(19) United States
(12) Patent Application Publication
(10) Pub. No.: US 2005/0198248 A1
(43) Pub. Date: Sep. 8, 2005

(54) System layout design program, system layout design apparatus, and system layout design method for automatically configuring systems

(75) Inventors: Kenji Morimoto, Kawasaki (JP); Akira Katsuno, Kawasaki (JP); Satoshi Kuroyanagi, Aichi (JP); Junichi Kawano, Kawasaki (JP); Shugo Ono, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 10/959,514

(22) Filed: Oct. 6, 2004

(30) Foreign Application Priority Data
Feb. 17, 2004 (JP) 2004-040425

(51) Int. Cl. G06F 15/173

(52) U.S. Cl. 709/223

(57) ABSTRACT

A system layout design program that can automatically generate an efficient system configuration. A system layout generation section associates units for performing functions indicated by logical system conditions with the logical system conditions and generates system layouts indicative of the association of the units with all of the logical system conditions. An evaluation section evaluates the system layouts generated by the system layout generation section on the basis of evaluation criteria designated in advance and stores a system layout evaluated most highly in a system layout storage section as a design result.

### CROSS-REFERENCE TO RELATED APPLICATIONS

This application is based on, and claims priority to, Japanese Patent Application No. 2004-040425, filed on Feb. 17, 2004, in Japan, the entire contents of which are incorporated herein by reference.

### BACKGROUND OF THE INVENTION

(1) Field of the Invention

This invention relates to a system layout design program, system layout design apparatus, and system layout design method for automatically configuring a plurality of systems and, more particularly, to a system layout design program, system layout design apparatus, and system layout design method for building a plurality of functions.

(2) Description of the Related Art

To provide services by information technology (IT), computer systems (IT infrastructure) which can efficiently perform processes and which can stably be operated must be built. Conventionally, the design of physical system layouts, the determination of items set on each node, and the setting of the items on each node have been performed manually to build IT infrastructure.

FIG. 24 shows an example of a conventional IT infrastructure system.

Conventionally, local terminal units 930 and 940 are connected to nodes 910 and 920, respectively, to be managed. A management node 950 is connected to the nodes 910 and 920 to be managed. The management node 950 manages the operating state of the nodes 910 and 920 to be managed. The node 910 to be managed includes a serial port 911, a physical resource control section 912, and a physical resource 913. Similarly, the node 920 to be managed includes a serial port 921, a physical resource control section 922, and a physical resource 923.

A system administrator designs a physical system manually and determines functions (a Web server function, for example) to be assigned to each of the nodes 910 and 920 to be managed. Then the system administrator operates the terminal units 930 and 940 to install predetermined functions and set various items (environments) on the nodes 910 and 920, respectively, to be managed. In this case, the system administrator operates the keyboards of the terminal units 930 and 940 to directly input commands. The contents of the commands are also generated manually on the basis of a diagram of the configuration of the entire system reviewed in advance.

Contents indicated by the commands are inputted to the nodes 910 and 920 to be managed via the corresponding serial ports 911 and 921 and are set in the corresponding physical resource control sections 912 and 922. When the operation of the system is begun, the physical resource control sections 912 and 922 control the physical resources 913 and 923, respectively, and the predetermined functions will be provided. The management node 950 monitors the operation state of the provided functions.

With such manual operation, however, there is a very fair possibility that an operation mistake will occur due to, for example, a misunderstanding in the setting, and it takes some time to completely build the system. In addition, with an increase in the scale of the IT infrastructure system, the design of the physical system becomes more difficult. This leads to an increase in the frequency of mis-setting at the time of building the system. Accordingly, a system which can easily design a physical system layout for any IT infrastructure system and which can decrease the frequency of mis-setting is devised.

For example, a network building support system for storing physical parameters for defining the physical configuration of information processing units and logical parameters for defining the logical configuration of a network in advance, for extracting contents to be set in the information processing units, and for setting the contents in the appropriate information processing units is disclosed (see, for example, Japanese Unexamined Patent Publication No. Hei8-95884).

Moreover, a simulator having the function of selecting units necessary for building a network system, the function of making a diagram of network structure in which the selected units are indicated as components, and the function of evaluating the diagram of network structure made is disclosed (see, for example, Japanese Unexamined Patent Publication No. 2003-101537).

Furthermore, a network system for automatically collecting information necessary for setting a computer network system and for automatically delivering parameters for setting network structure to each node is disclosed (see, for example, Japanese Unexamined Patent Publication No. Hei8-110878).

In addition, a network management system including a database in which information corresponding to computers and network devices is stored for making a diagram of network specifications that meet conditions requested by a user from each piece of information and for checking that the network specifications meet physical elements is disclosed (see, for example, Japanese Unexamined Patent Publication No. Hei5-225104).

As stated above, with an increase in the scale of the system, the design of the physical system becomes more complex. Therefore, it is difficult for the system administrator to design the system only with his/her knowledge and experience. Moreover, the system is built manually, so an increase in the scale of the system will lead to an increase in the number of man-hours. As a result, the number of problems caused by, for example, operation mistakes will increase. The increase in the number of man-hours and the increase in the number of problems will lead to a rise in the total cost of ownership (TCO) including the cost of building the system.

A system for automatically making a diagram of network specifications is disclosed in the above Japanese Unexamined Patent Publication No. Hei5-225104. However, this system only establishes network specifications that meet physical requirements and cannot automatically search for an efficient system configuration. That is to say, if a plurality of patterns of network specifications meet the physical requirements, this system cannot select an efficient system configuration from among these patterns of network specifications. An increase in the scale of an IT infrastructure system will lead to an increase in the number of system configurations that meet physical requirements. It is difficult for the system administrator to judge at need which of these system configurations enables high processing efficiency.

### SUMMARY OF THE INVENTION

The present invention was made under the background circumstances described above. An object of the present invention is to provide a system layout design program, system layout design apparatus, and system layout design method capable of automatically generating an efficient system configuration.

In order to achieve the above object, a system layout design program for determining the arrangement of a plurality of functions on a network to be managed is provided. This system layout design program makes a computer perform a storage process for storing a logical system condition table in which a plurality of logical system conditions indicative of functions to be performed on the network to be managed are stored and a physical system information table in which physical element information indicative of a plurality of units included in the network to be managed and the connection state of the plurality of units is stored in a storage unit, a system layout generation process for associating the plurality of units for performing the functions indicated by the plurality of logical system conditions with the plurality of logical system conditions and for generating system layouts indicative of the association of the plurality of units with all of the plurality of logical system conditions, and an evaluation process for evaluating the system layouts generated in the system layout generation process on the basis of evaluation criteria designated in advance and for storing a system layout evaluated most highly in a system layout storage section as a design result.

Furthermore, in order to achieve the above object, a system layout design apparatus for determining the arrangement of a plurality of functions on a network to be managed is provided. This system layout design apparatus comprises a logical system condition table in which a plurality of logical system conditions indicative of functions to be performed on the network to be managed are stored, a physical system information table in which physical element information indicative of a plurality of units included in the network to be managed and the connection state of the plurality of units is stored, a system layout generation section for associating the plurality of units for performing the functions indicated by the plurality of logical system conditions with the plurality of logical system conditions and for generating system layouts indicative of the association of the plurality of units with all of the plurality of logical system conditions, and an evaluation section for evaluating the system layouts generated by the system layout generation section on the basis of evaluation criteria designated in advance and for storing a system layout evaluated most highly in a system layout storage section as a design result.

In addition, in order to achieve the above object, a system layout design method for determining the arrangement of a plurality of functions on a network to be managed is provided. This system layout design method comprises a step performed by an input section for storing a logical system condition table in which a plurality of logical system conditions indicative of functions to be performed on the network to be managed are stored and a physical system information table in which physical element information indicative of a plurality of units included in the network to be managed and the connection state of the plurality of units is stored in a storage unit, a step performed by a system layout generation section for associating the plurality of units for performing the functions indicated by the plurality of logical system conditions with the plurality of logical system conditions and for generating system layouts indicative of the association of the plurality of units with all of the plurality of logical system conditions, and a step performed by an evaluation section for evaluating the system layouts generated by the system layout generation section on the basis of evaluation criteria designated in advance and for storing a system layout evaluated most highly in a system layout storage section as a design result.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view for describing the present invention applied to embodiments.

FIG. 2 shows an example of a system configuration according to a first embodiment of the present invention.

FIG. 3 shows an example of the hardware configuration of a management node.

FIG. 4 is a block diagram showing the processing function of the management node.

FIG. 5 shows the detailed structure of a layout design condition database and a system layout design section.

FIG. 6 shows an example of the data structure of a priority value setting table.

FIG. 7 shows an example of the data structure of a logical system condition table.

FIG. 8 shows an example of a logical system layout.

FIG. 9 shows an example of the data structure of a physical system information table.

FIG. 10 shows a physical system layout for a network to be managed.

FIG. 11 shows an example of the data structure of a layout table.

FIG. 12 shows an example of a generated system layout.

FIG. 13 shows an example of the data structure of a layout evaluation table.

FIG. 14is a flow chart showing a procedure for a physical system layout design process.

FIG. 15 is a flow chart showing a procedure for a layout generation process.

FIG. 16 shows an example of the data structure of a setting file template table.

FIG. 17 shows an example of a setting file template.

FIG. 18 shows an example of the data structure of a setting file management table.

FIG. 19 shows an example of the data structure of a configuration control agent management table.

FIG. 20 is a first flow chart showing a procedure for a deployment process.

FIG. 21 is a second flow chart showing the procedure for the deployment process.

FIG. 22 is a third flow chart showing the procedure for the deployment process.

FIG. 23 shows an example of a system configuration according to a second embodiment of the present invention.

FIG. 24 shows an example of a conventional IT infrastructure system.

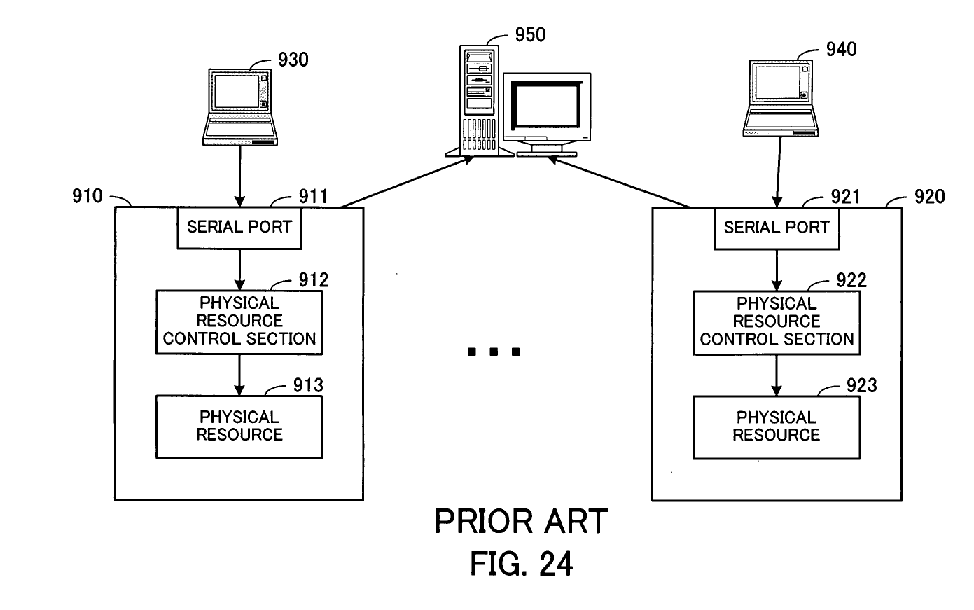

### DESCRIPTION OF THE PREFERRED EMBODIMENTS

Embodiments of the present invention will now be described with reference to the drawings.

An overview of the present invention applied to embodiments will be given first and then the contents of the embodiments will be described concretely.

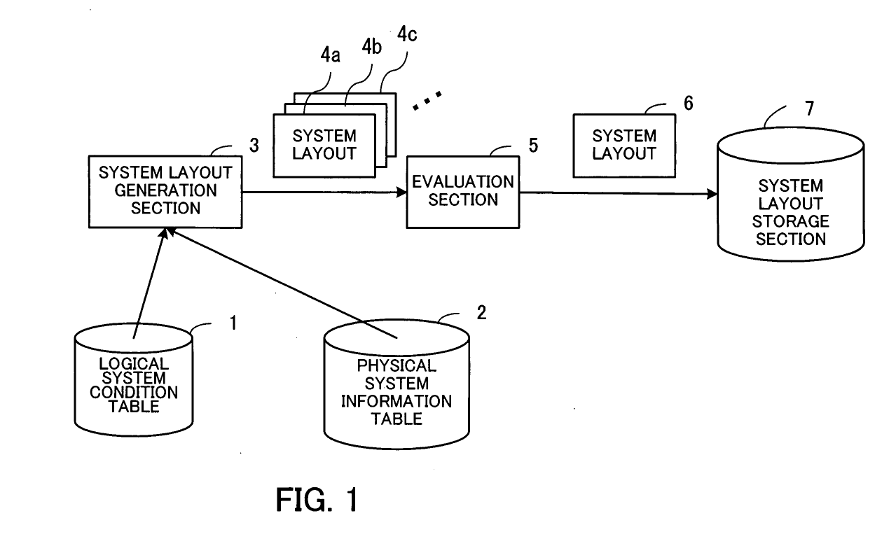

FIG. 1 is a schematic view for describing the present invention applied to embodiments. The present invention comprises a logical system condition table 1, a physical system information table 2, a system layout generation section 3, an evaluation section 5, and a system layout storage section 7.

The logical system condition table 1 stores a plurality of logical system conditions indicative of functions to be performed on a network to be managed. For example, individual nodes, interfaces, specifications for them, information regarding connection among the nodes are registered in the logical system condition table 1. The physical system information table 2 stores physical element information indicative of a plurality of units that make up the network to be managed and the connection state of the plurality of units. For example, hardware attribute information, location (route) information, failure information, and performance information are registered in the physical system information table 2.

The system layout generation section 3 associates units for performing the functions indicated by the logical system conditions with the logical system conditions and generates system layouts 4a, 4b, 4c, and so on indicative of the association of the units with all of the logical system conditions.

For example, the system layout generation section 3 assumes a server (seed server) which is a starting point in the logical system conditions and associates the functions indicated by the logical system conditions with physical resources with this server as a base. To be concrete, the system layout generation section 3 searches for an adjacent server in a logical system with the seed server as a starting point and arranges and wires the adjacent server and an interface between the seed server and the adjacent server as physical resources. By extending this connection relationship, the association of all of the servers with physical resources will be completed.

Similarly, the system layout generation section 3 searches for a server and a storage adjacent to a storage which is a starting point in the logical system conditions. Then the system layout generation section 3 associates an interface between the adjacent server and storage and an object storage node with physical resources. By extending this connection relationship, all of the storages will be associated with physical resources.

The evaluation section 5 evaluates the system layouts 4a, 4b, 4c, and so on generated by the system layout generation section 3 in accordance with evaluation criteria designated in advance and stores a system layout 6 that the evaluation section 5 evaluates most highly in the system layout storage section 7 as a design result. For example, the evaluation section 5 checks whether each of the system layouts 4a, 4b, 4c, and so on meets the logical system conditions, and verifies the performance (such as network bandwidth and CPU performance) of each of the system layouts 4a, 4b, 4c, and so on. By doing so, the evaluation section 5 checks whether there is a logical/physical inconsistency or lack of performance in the entire system. If there is an inconsistency or lack of performance, then the evaluation section 5 requests the system layout generation section 3 to perform mapping again under conditions that can solve the problem.

In the above system, the system layout generation section 3 associates units for performing the functions indicated by the logical system conditions with the logical system conditions and generates the system layouts 4a, 4b, 4c, and so on indicative of the association of the units with all of the logical system conditions. Then the evaluation section 5 evaluates the system layouts 4a, 4b, 4c, and so on generated by the system layout generation section 3 in accordance with the evaluation criteria designated in advance and stores the system layout 6 that the evaluation section 5 evaluates most highly in the system layout storage section 7 as a design result. The system layout 6 is mapping information indicative of association between logical elements (processing functions to be built according to units) and physical elements (units that make up the network to be managed).

For example, if the system layouts 4a, 4b, 4c, and so on are evaluated in accordance with the evaluation criteria in which priority is given to system stability, then a highly reliable system layout can be obtained. On the other hand, if the system layouts 4a, 4b, 4c, and so on are evaluated in accordance with the evaluation criteria in which priority is given to processing efficiency, then a system layout that achieves high processing efficiency can be obtained.

These functions of the present invention can effectively be used for automating processes from the determination of a logical system to the setting and deployment of each node in an IT infrastructure system made up of servers, storage, and networks to avoid the complexity of system design and mis-setting.

Priority can be set in advance among the logical system conditions in the logical system condition table 1. For example, high priority is assigned to a logical system condition that imposes a tough restriction on CPU processing speed, a data transfer rate, memory capacity, or the like. If a logical system condition regarding CPU processing speed requires a higher CPU operating frequency, then a tougher restriction will be imposed. If priority is set in advance among the logical system conditions, the system layout generation section 3 associates the units for performing the functions indicated by the logical system conditions with the logical system conditions in descending order of priority. As a result, a system layout that meets all of the logical system conditions can be found in a short period of time.

In addition, each time the system layout generation section 3 generates a system layout, the evaluation section 5 may calculate an evaluation value indicative of an evaluation of the system layout generated. In this case, a system layout the evaluation value of which is greater than or equal to a predetermined value (threshold) is treated as a design result. As a result, even if a plurality of system layouts that meet all of the logical system conditions can be generated, it is possible to terminate the process without generating all of these system layouts. This reduces time taken to perform the process of generating a system layout.

Furthermore, if there are a plurality of patterns for the association of the units for performing the functions indicated by the logical system conditions with the logical system conditions, the following method may be used. The system layout generation section 3 obtains an evaluation of a partial layout indicated in each association pattern from the evaluation section 5, fixes a partial layout the evaluation section 5 highly evaluates, and examines units associated with the other logical system conditions. As a result, a depth-first search is performed. In the depth-first search, edges are followed from one vertex as far as possible. When it is impossible to go further, the return is made to select another route. Compared with a breadth-first search, such a depth-first search enables quick generation of a system layout the evaluation section 5 highly evaluates.

That is to say, in the breadth-first search, after a partial layout that meets a logical system condition is generated, other partial layouts that meet the logical system condition are searched for in order. Then partial layouts that meet the next logical system condition are selected from among the partial layouts generated. Such a breadth-first search will involve a great many processes to generate a system layout that meets all of the logical system conditions.

On the other hand, a depth-first search enables quick generation of a system layout that meets the logical system conditions. If this system layout satisfies predetermined evaluation criteria, it can be treated as a design result. This reduces time taken to perform the process of designing a system layout.

In addition, a setting file generation section for generating a setting file used for implementing functions according to a system layout stored in the system layout storage section on the units that make up the network to be managed may be included. The setting file generation section has, for example, a setting file template in advance. By putting information regarding each unit in the system layout registered with the system layout storage section into a predetermined position in the setting file template, a setting file for each unit is generated. The setting file template includes set items for each physical resource, parameters, and patterns of a combination of set items.

To be concrete, the setting file generation section divides the system layout according to physical topologies (products). On the basis of the setting file template, the setting file generation section extracts set items for each physical topology and determines parameters to be used. Then the setting file generation section generates a batch format or a disk image suitable for each product. By automatically generating a setting file, the network to be managed can be built easily in accordance with the system layout designed.

Furthermore, a configuration control management section for remotely controlling the units that make up the network to be managed and setting environments for the units on the basis of setting files generated by the setting file generation section may be included. By doing so, the network to be managed can be built automatically in accordance with the system layout designed. That is to say, the configuration control management section ensures that the setting file (or batch file or disk image) generated by the setting file generation section will be reflected in each node. To be concrete, the configuration control management section manages the address of each node, cooperates with each node via the network, and sends data. A configuration control agent at each node to be managed cooperates with a management node, receives data, and has a setting file reflected in the setting of hardware.

This saves the trouble of performing manual operation, reduces operation mistakes in building a system, and improves the speed of building the system. Moreover, this reduces time for which the provision of services are interrupted to change a system which is in operation.

The configuration control management section should set an environment for each switch located on a communication path between units last of all. This prevents mismatching processing caused by communication between a unit an environment for which has already been set in accordance with a designed system layout and a unit an environment for which has not been set yet.

As described above, the function of a system in a network to be managed to automatically build in accordance with a system layout automatically designed is highly effective in managing the network. Accordingly, an embodiment in which a management node remotely operates a node to be used as a Web server to install application software for Web servers on the node and to set an environment for the node will now be described in detail.

### First Embodiment

A first embodiment of the present invention will be described first.

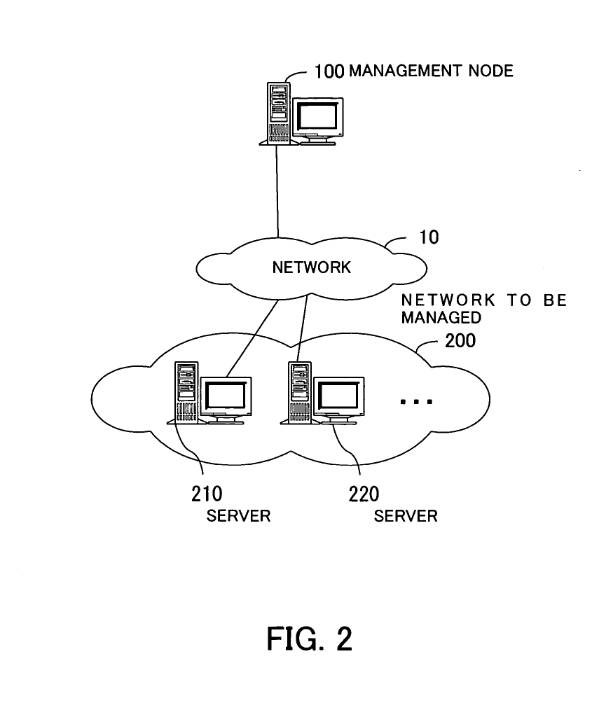

FIG. 2 shows an example of a system configuration according to a first embodiment of the present invention. A management node 100 is connected to nodes, such as servers 210 and 220, to be managed on a network 200 to be managed via a network 10. The management node 100 determines a physical system layout indicative of a physical resource used for realizing the function of a logical resource to be built on the network 200 to be managed on the basis of the logical resource and physical resources on the network 200 to be managed.

In addition, the management node 100 remotely operates the nodes, such as the servers 210 and 220, to be managed to build a function on them in accordance with the physical system layout.

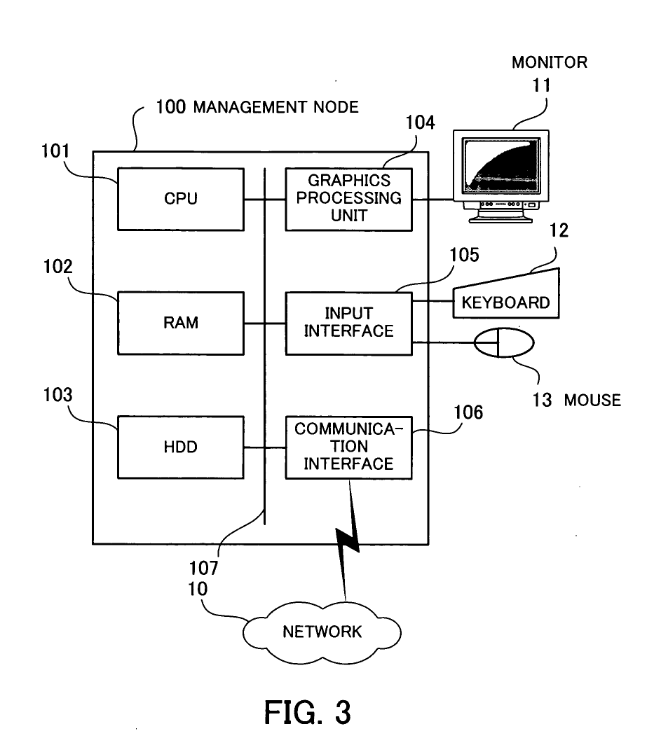

FIG. 3 shows an example of the hardware configuration of a management node. The entire management node 100 is controlled by a central processing unit (CPU) 101. A random access memory (RAM) 102, a hard disk drive (HDD) 103, a graphics processing unit 104, an input interface 105, and a communication interface 106 are connected to the CPU 101 via a bus 107.

The RAM 102 temporarily stores at least part of an operating system (OS) or an application program executed by the CPU 101. The RAM 102 stores various pieces of data which the CPU 101 needs to perform a process. The HDD 103 stores the OS and application programs.

A monitor 11 is connected to the graphics processing unit 104. In accordance with instructions from the CPU 101, the graphics processing unit 104 displays an image on the screen of the monitor 11. A keyboard 12 and a mouse 13 are connected to the input interface 105. The input interface 105 sends a signal sent from the keyboard 12 or the mouse 13 to the CPU 101 via the bus 107.

The communication interface 106 is connected to the network 10. The communication interface 106 exchanges data with another computer via the network 10.

A processing function in this embodiment can be realized by the above hardware configuration. In FIG. 3, an example of the hardware configuration of the management node 100 is shown. The servers 210 and 220 can also be realized by the same hardware configuration.

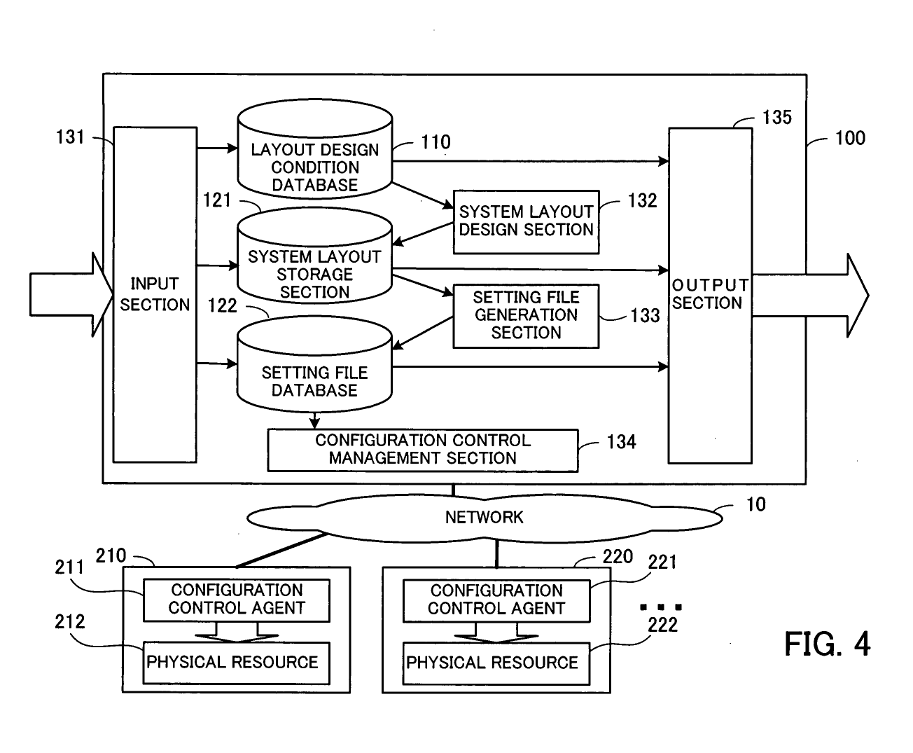

FIG. 4 is a block diagram showing the processing function of the management node. As shown in FIG. 4, the management node 100 includes a layout design condition database (DB) 110, a system layout storage section 121, a setting file DB 122, an input section 131, a system layout design section 132, a setting file generation section 133, a configuration control management section 134, and an output section 135.

Conditions necessary for designing a system layout for the network to be managed are registered in the layout design condition DB 110. The details of information registered in the layout design condition DB 110 will be described later.

Information (system layout) indicative of a processing function to be performed by a component in the network to be managed associated with the component is registered with the system layout storage section 121. For example, a node to be managed is registered as a Web server that assures security. This system layout is registered by the system layout design section 132. Information set in the system layout storage section 121 can be changed by the input section 131.

The function (system layout) of a particular node to be managed can be designated in advance in the system layout storage section 121. This designation is performed by an administrator via the input section 131. When the function of a node to be managed is designated in advance, the correspondence between the function and the node to be managed is fixed as an established partial layout.

Items set for the components of the network 200 to be managed by remote operation and the contents of the items set are registered in the setting file DB 122. These pieces of information are set by the setting file generation section 133. Information set in the setting file DB 122 can be changed by the input section 131.

The input section 131 registers various pieces of information in the management node 100 in response to, for example, input operation by the administrator. To be concrete, the input section 131 registers conditions necessary for layout design in the layout design condition DB 110. Furthermore, the input section 131 updates information set in the system layout storage section 121 or the setting file DB 122.

The system layout design section 132 refers to the layout design condition DB 110 and designs a system layout for the network 200 to be managed. The system layout designed is registered with the system layout storage section 121. The details of the system layout design section 132 will be described later.

The setting file generation section 133 generates a setting file in which the contents of functions and logical connection set for physical units are described. To be concrete, the setting file generation section 133 refers to the system layout registered with the system layout storage section 121 and generates items set for the components of the network 200 to be managed and the contents of the items. Then the setting file generation section 133 registers a setting file including the items it generates and the contents of the items in the setting file DB 122.

The configuration control management section 134 has the function of reflecting the result of the system layout in a physical system. To be concrete, the configuration control management section 134 communicates with the nodes (such as the servers 210 and 220) to be managed that make up the network 200 to be managed via the network 10 and performs predetermined setting on them. For example, the configuration control management section 134 sets environments (installs programs and sets parameters) for the nodes, such as the servers 210 and 220, to be managed by distributing and applying setting files in which settings for the physical elements are defined to the physical elements.

In response to, for example, input operation by the administrator, the output section 135 outputs information registered in the layout design condition DB 110, the system layout storage section 121, and the setting file DB 122 to the screen of the monitor 11, another node connected via the network, or the like.

The server 210 includes a configuration control agent 211 and a physical resource 212. The configuration control agent 211 communicates with the management node 100 and controls the server 210 in response to a request from the management node 100. For example, the configuration control agent 211 installs software for realizing a predetermined processing function and assigns the physical resource 212 to this function.

The physical resource 212 is hardware functions, such as an operation function by a CPU, a temporary data storage function by a RAM, and a data storage function by an HDD, included in the server 210. The physical resource 212 can be assigned arbitrarily to a processing function. For example, by setting CPU occupancy of each processing function (such as a Web server), the operation function by the CPU can be assigned.

The server 220 includes a configuration control agent 221 and a physical resource 222. The functions of the configuration control agent 221 and the physical resource 222 are the same as those of the configuration control agent 211 and the physical resource 212, respectively, in the server 210.

In FIG. 4, the servers 210 and 220 are shown as examples of a node to be managed. However, other nodes, such as network switches, to be managed also include a configuration control agent and a physical resource.

The details of the layout design condition DB 110 and the system layout design section 132 will now be described.

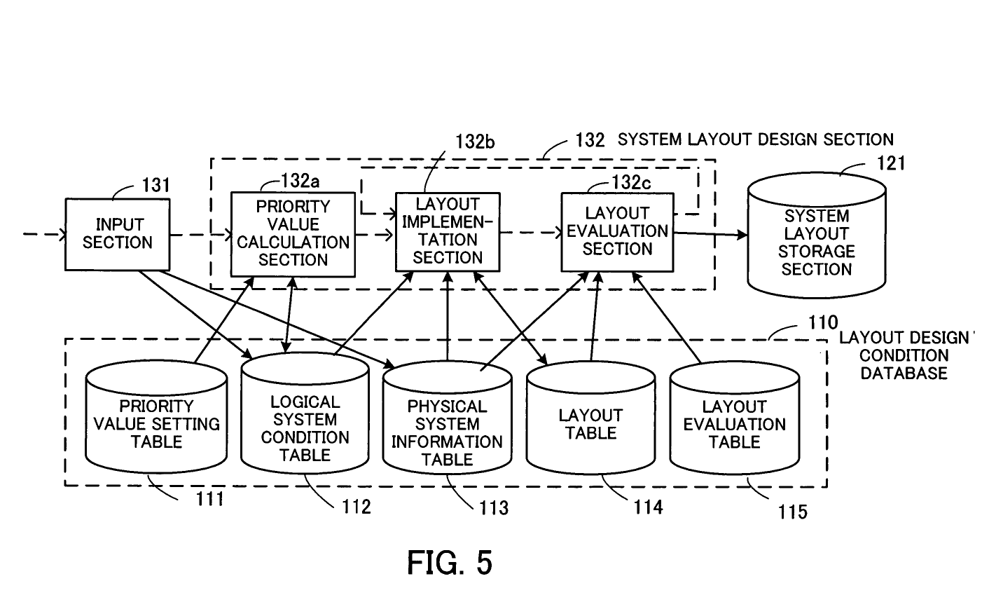

FIG. 5 shows the detailed structure of the layout design condition DB and the system layout design section. The details of the layout design condition DB 110 will be described first. In FIG. 5, each dashed arrow indicates a transfer of control information, such as instructions to begin processing. Each solid arrow indicates a transfer of data to be processed.

The layout design condition DB 110 includes a priority value setting table 111, a logical system condition table 112, a physical system information table 113, a layout table 114, and a layout evaluation table 115.

Each time system layout design is made, new data is registered in the logical system condition table 112 and the physical system information table 113. The priority value setting table 111 and the layout evaluation table 115 include information necessary for performing a system layout design process. These tables are recorded in advance on a nonvolatile record medium, such as the HDD. The layout table 114 includes intermediate data generated during the system layout design process.

Priority for examining logical system conditions is defined in the priority value setting table 111. For example, a higher priority value is assigned to a logical system condition that imposes a tougher restriction. The contents of the priority value setting table 111 can be changed freely by the administrator by using the input section 131.

Information (logical system condition) indicative of the logical structure of a function to be built on the network 200 to be managed is registered in the logical system condition table 112. A logical system condition indicates a processing function to be provided and the performance of the processing function. For example, a piece of information indicative of logical structure indicates that a Web server which assures security is provided by a resource corresponding to a CPU power of 2 GHz. This information is registered via the input section 131. The logical system condition registered in the logical system condition table 112 may be generated automatically on the basis of a diagram of a logical system configuration made by, for example, CAD.

The structure of hardware (physical) resources included in the network 200 to be managed is registered in the physical system information table 113. For example, the physical system information table 113 holds the physical attributes (such as performance) of the components of the network 200 to be managed and connection relationships among them.

A system layout generated is stored temporarily in the layout table 114.

Evaluation criteria for the system layout generated are registered in the layout evaluation table 115. The contents of the layout evaluation table 115 can be changed freely by the administrator by using the input section 131.

The system layout design section 132 includes a priority value calculation section 132a, a layout implementation section 132b, and a layout evaluation section 132c.

The priority value calculation section 132a refers to the priority value setting table 111 and sets the priority value of each logical system condition in the logical system condition table 112.

The layout implementation section 132b refers to the logical system condition table 112 and the physical system information table 113 and generates a system layout that meets the logical system conditions by combining resources in a physical system. The system layout generated is registered in the layout table 114.

The layout evaluation section 132c refers to the physical system information table 113, the layout table 114, and the layout evaluation table 115 and evaluates system layouts generated. The layout evaluation section 132c registers a system layout the evaluation value of which is the greatest with the system layout storage section 121.

Furthermore, the layout evaluation section 132c can terminate the process of generating a system layout at the time when a system layout that satisfies predetermined evaluation criteria is obtained. If the evaluation value of the system layout generated is greater than a predetermined value (threshold), then the layout evaluation section 132c registers it with the system layout storage section 121. If the evaluation value of it is not greater than the predetermined value, then the layout evaluation section 132c requests the layout implementation section 132b to generate another system layout. In response to the request from the layout evaluation section 132c, the layout implementation section 132b begins to generate the next system layout.

A system layout is designed on the basis of the structure shown in FIG. 5. In the system layout design process, first the priority value calculation section 132a calculates the priority value of each logical system condition by referring to the priority value setting table 111.

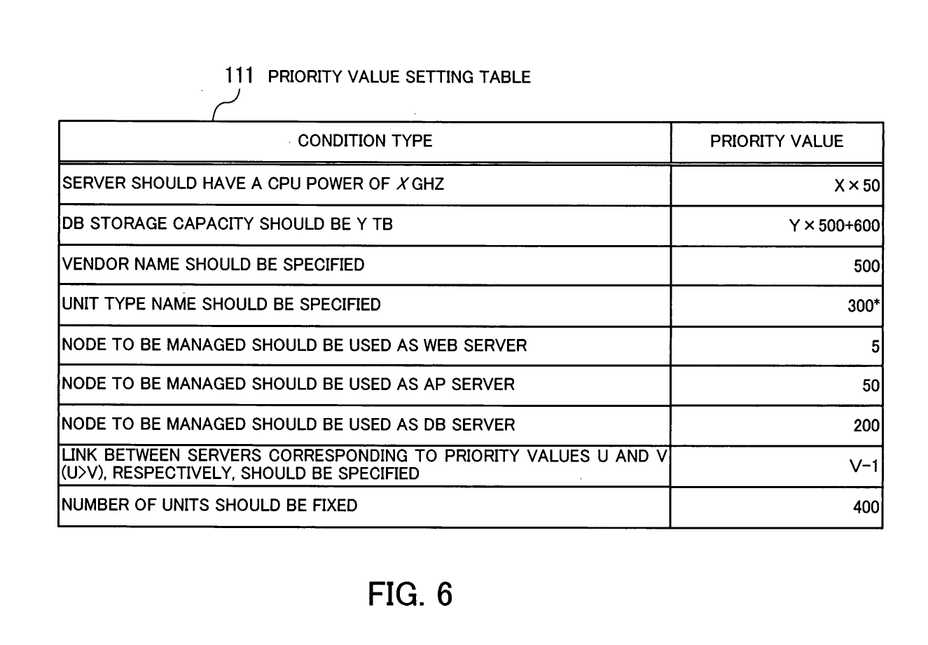

FIG. 6 shows an example of the data structure of a priority value setting table. Condition types and priority values corresponding to these condition types are set in the priority value setting table 111. The priority value of one logical system condition is obtained by totaling the priority values of all of the items that apply to the logical system condition.

If the condition that a server should have a CPU power of X GHz (X is a real number that indicates the operating frequency of the CPU in gigahertz) is set as a condition regarding the processing capability of the CPU, a priority value corresponding to this condition is given by X×50. That is to say, a priority value corresponding to a condition regarding the processing capability of the CPU is proportional to a required operating frequency (processing capability value) of the CPU.

If the condition that DB storage capacity should be Y TB (Y is a real number that indicates storage capacity in terabytes) is set as a condition regarding DB storage capacity (storage capacity for accumulating data), a priority value corresponding to this condition is given by Y×500+600. That is to say, a priority value corresponding to a condition regarding DB storage capacity becomes greater with an increase in capacity.

If a vendor name is specified (condition that a unit supplied from a specified vendor should be used), a priority value corresponding to this condition is 500.

If a unit type name is specified (condition that a unit of a specified type should be used), a priority value corresponding to this condition is 300. If a unit type name is specified, a vendor name is always specified. Accordingly, if a unit type name is specified, the priority value “300” given by specifying the unit type name is added to the priority value “500” given by specifying the vendor name.

If the condition that a node to be managed should be used as a Web server is set, a priority value corresponding to this condition is 5.

If the condition that a node to be managed should be used as an AP server is set, a priority value corresponding to this condition is 50.

If the condition that a node to be managed should be used as a DB server is set, a priority value corresponding to this condition is 200.

If a link between servers corresponding to priority values U and V (U and V are real numbers indicative of priority values for server functions and U>V), respectively, is specified, a priority value corresponding to this condition is given by V−1. For example, If a link between a Web server (priority value is 5) and a DB server (priority value is 200) is specified, then U=200 and V=5. Therefore, the priority value “4 (=5−1)” is given by specifying this link.

If the number of units is fixed (if the number of units to be used is specified), a priority value is 400.

The priority values of logical system conditions can be calculated on the basis of the priority value setting table 111. That is to say, the priority value calculation section 132a extracts condition types a logical system condition meets from the priority value setting table 111. Then the priority value calculation section 132a makes the total of priority values corresponding to the extracted condition types the priority value of the logical system condition. The priority value calculation section 132a registers the calculated priority value in the logical system condition table 112.

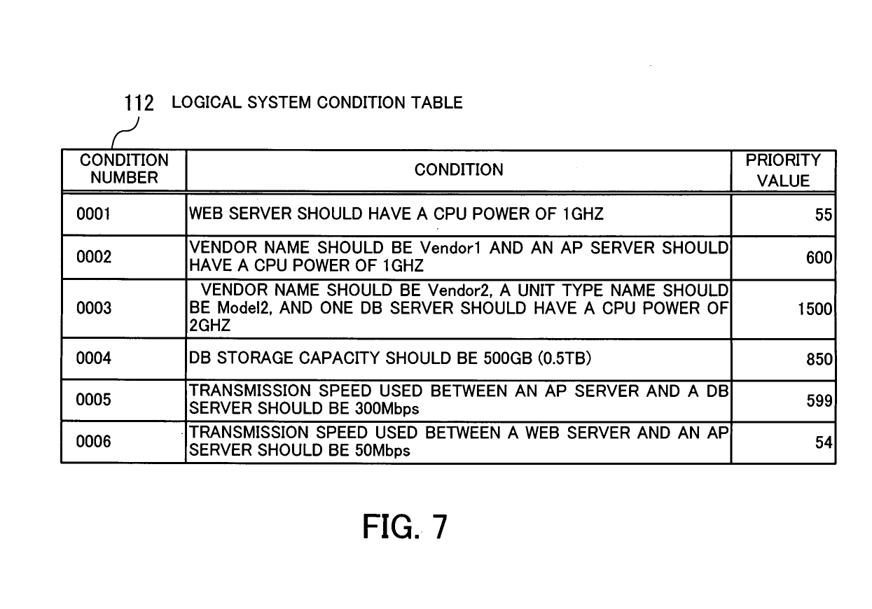

FIG. 7 shows an example of the data structure of a logical system condition table. Condition numbers, conditions, and priority values are associated with one another and are registered in the logical system condition table 112. Condition Number indicates the identification number of each registered logical system condition. Condition indicates the contents of each logical system condition. Priority Value indicates a priority value calculated by the priority value calculation section 132a.

The condition number “0001” is assigned to the logical system condition “a Web server should have a CPU power of 1 GHz”. This logical system condition satisfies the condition type “a server should have a CPU power of 1 GHz” (priority value is 50) and the condition type “a node to be managed should be used as a Web server” (priority value is 5) in the priority value setting table 111. Accordingly, the value “55” obtained by totaling the priority values corresponding to these condition types is the priority value of this logical system condition.

The condition number “0002” is assigned to the logical system condition “a vendor name should be Vendor1 and an AP server should have a CPU power of 1 GHz”. This logical system condition satisfies the condition type “a server should have a CPU power of 1 GHz” (priority value is 50), the condition type “a node to be managed should be used as an AP server” (priority value is 50), and the condition type “a vendor name (Vendor1) should be specified” (priority value is 500) in the priority value setting table 111. Accordingly, the value “600” obtained by totaling the priority values corresponding to these condition types is the priority value of this logical system condition.

The condition number “0003” is assigned to the logical system condition “a vendor name should be Vendor2, a unit type name should be Model2, and one DB server should have a CPU power of 2 GHz”. This logical system condition satisfies the condition type “a server should have a CPU power of 2 GHz” (priority value is 100), the condition type “a node to be managed should be used as a DB server” (priority value is 200), the condition type “a vendor name (Vendor2) should be specified” (priority value is 500), the condition type “a unit type name (Model2) should be specified” (priority value is 300), and the condition type “the number (one) of units should be fixed” (priority value is 400) in the priority value setting table 111. Accordingly, the value “1500” obtained by totaling the priority values corresponding to these condition types is the priority value of this logical system condition.

The condition number “0004” is assigned to the logical system condition “DB storage capacity should be 500 GB (0.5 TB)”. This logical system condition satisfies the condition type “DB storage capacity should be 0.5 TB” (priority value is 850) in the priority value setting table 111. Accordingly, the priority value “850” corresponding to this condition type is the priority value of this logical system condition.

The condition number “0005” is assigned to the logical system condition “transmission speed used between an AP server and a DB server should be 300 Mbps”. This logical system condition satisfies the condition type “a link between servers corresponding to the priority values U=1500 (DB server) and V=600 (AP server) should be specified” (priority value is 599 (=V−1)) in the priority value setting table 111. Priority values for these servers are known by referring to the values associated with the condition numbers “0002” and “0003” and registered. Accordingly, the priority value “599” corresponding to this condition type is the priority value of this logical system condition.

The condition number “0006” is assigned to the logical system condition “transmission speed used between a Web server and an AP server should be 50 Mbps”. This logical system condition satisfies the condition type “a link between servers corresponding to the priority values U=600 (AP server) and V=55 (Web server) should be specified” (priority value is 54 (=V−1)) in the priority value setting table 111. Accordingly, the priority value “54” corresponding to this condition type is the priority value of this logical system condition.

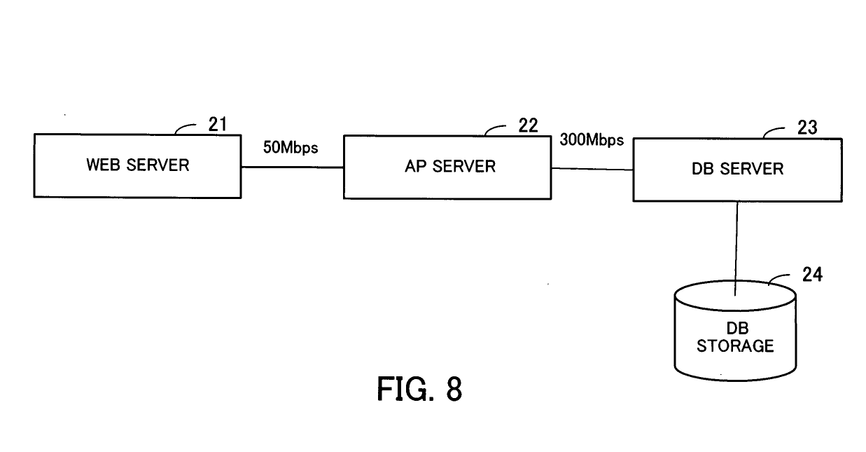

FIG. 8 shows an example of a logical system layout. In FIG. 8, logical system structure that meets the conditions specified in the logical system condition table shown in FIG. 7 is shown. In this logical system structure, a Web server 21, an AP server 22, a DB server 23, and DB storage 24 are included. Their performance is higher than or equal to that shown in FIG. 7. The Web server 21 and the AP server 22 are connected by a transmission medium by which communication can be performed at a transmission speed higher than or equal to 50 Mbps. The AP server 22 and the DB server 23 are connected by a transmission medium by which communication can be performed at a transmission speed higher than or equal to 300 Mbps.

When the priority value of a logical system condition is calculated, the layout implementation section 132b refers to the logical system condition table 112 and the physical system information table 113 and generates a system layout.

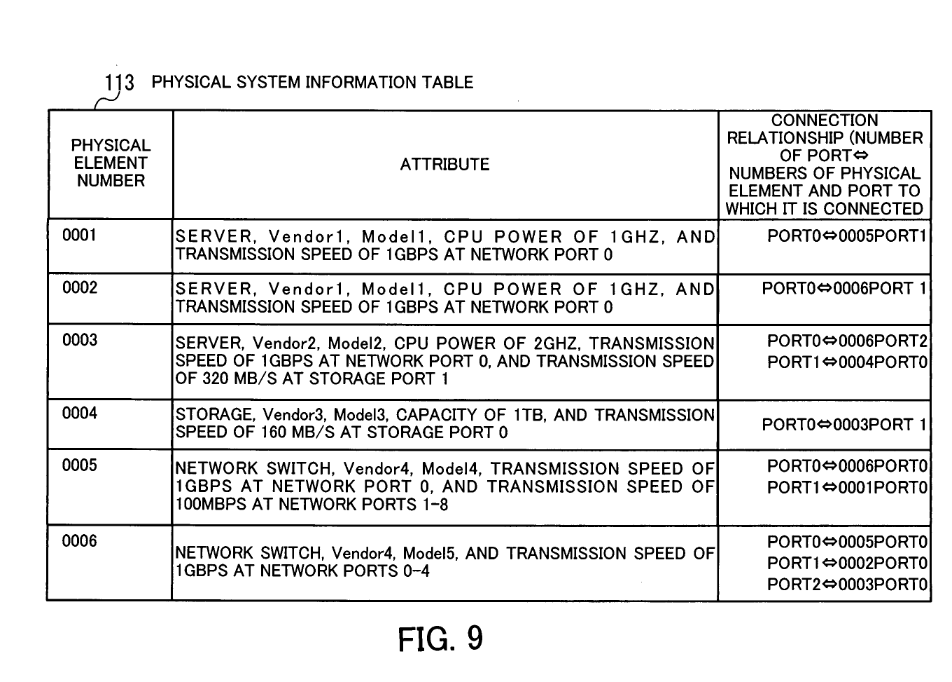

FIG. 9 shows an example of the data structure of a physical system information table. Physical element numbers, attributes, and connection relationships are associated with one another and are registered in the physical system information table 113. Physical Element Number indicates the identification number of each component (physical element) of a physical system. Attribute indicates the type and function of each component of the physical system. Connection Relationship indicates a connection relationship between physical elements.

The physical element number “0001” is assigned to the physical element “a server, Vendor1, Model1, a CPU power of 1 GHz, and a transmission speed of 1 Gbps at network port 0”. The port 0 in this physical element is connected to port 1 in the physical element indicated by the physical element number “0005”.

The physical element number “0002” is assigned to the physical element “a server, Vendor1, Model1, a CPU power of 1 GHz, and a transmission speed of 1 Gbps at network port 0”. The port 0 in this physical element is connected to port 1 in the physical element indicated by the physical element number “0006”.

The physical element number “0003” is assigned to the physical element “a server, Vendor2, Model2, a CPU power of 2 GHz, a transmission speed of 1 Gbps at network port 0, and a transmission speed of 320 MB/s at storage port 1”. The port 0 in this physical element is connected to port 2 in the physical element indicated by the physical element number “0006”. Furthermore, the port 1 in this physical element is connected to port 0 in the physical element indicated by the physical element number “0004”.

The physical element number “0004” is assigned to the physical element “storage, Vendor3, Model3, a capacity of 1 TB, and a transmission speed of 160 MB/s at storage port 0”. The port 0 in this physical element is connected to the port 1 in the physical element indicated by the physical element number “0003”.

The physical element number “0005” is assigned to the physical element “a network switch, Vendor4, Model4, a transmission speed of 1 Gbps at network port 0, and a transmission speed of 100 Mbps at network ports 1-8”. The port 0 in this physical element is connected to port 0 in the physical element indicated by the physical element number “0006”. Furthermore, the port 1 in this physical element is connected to the port 0 in the physical element indicated by the physical element number “0001”.

The physical element number “0006” is assigned to the physical element “a network switch, Vendor4, Model5, and a transmission speed of 1 Gbps at network ports 0-4”. The port 0 in this physical element is connected to the port 0 in the physical element indicated by the physical element number “0005”. The port 1 in this physical element is connected to the port 0 in the physical element indicated by the physical element number “0002”. The port 2 in this physical element is connected to the port 0 in the physical element indicated by the physical element number “0003”.

By registering such physical system information in the physical system information table 113 in the management node 100, the management node 100 recognizes a physical system layout for the network 200 to be managed.

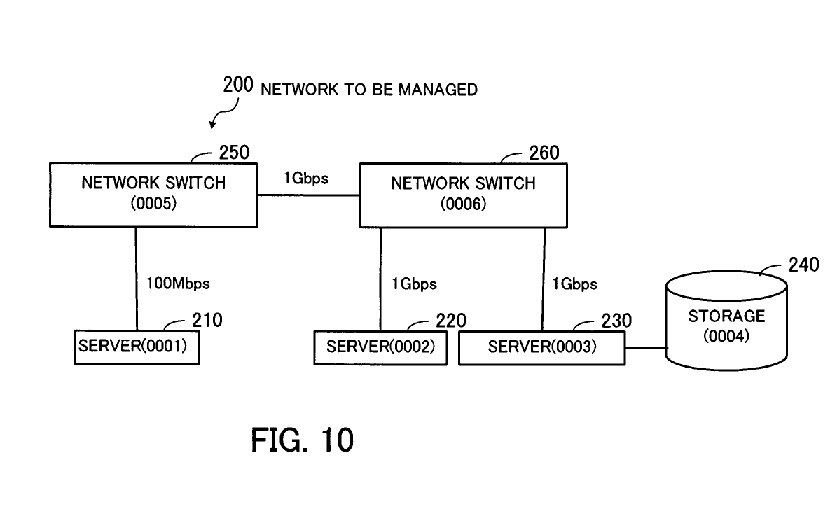

FIG. 10 shows a physical system layout for the network to be managed. In FIG. 10, the network 200 to be managed represented by the physical system information shown in FIG. 9 is shown. As shown in FIG. 10, the network 200 to be managed includes three servers 210, 220, and 230, one storage unit 240, and two network switches 250 and 260. In FIG. 10, the physical element number of each server is shown in parentheses.

The layout implementation section 132b generates a system layout for the network 200 to be managed that meets logical system conditions shown in FIG. 7 and registers it in the layout table 114.

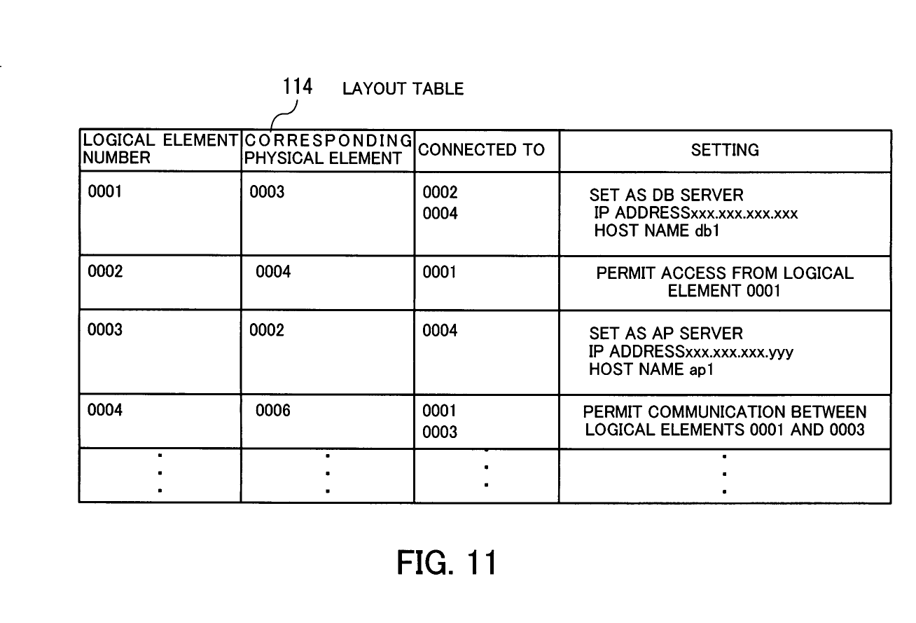

FIG. 11 shows an example of the data structure of a layout table. Logical element numbers, corresponding physical elements, connection relationships among logical elements, and settings are associated with one another and are registered in the layout table 114.

Logical Element Number indicates an identification number assigned to each logical element. A logical element is a unit of a function performed by one physical element. That is to say, each logical system condition is realized by one or more logical elements.

Corresponding Physical Element indicates the identification number of a physical element that performs the function of an associated logical element. Connected to indicates the identification number of an associated logical element to which it is connected. Setting indicates items to be set for an appropriate physical element and the contents of the items.

A physical element the physical element number of which is 0003 is assigned to a logical element the logical element number of which is 0001. This logical element is connected to logical elements the logical element numbers of which are 0002 and 0004 respectively. The physical element the physical element number of which is 0003 functions as a DB server and the IP address “xxx.xxx.xxx.xxx” and the host name “db1” are set.

A physical element the physical element number of which is 0004 is assigned to a logical element the logical element number of which is 0002. This logical element is connected to the logical element the logical element number of which is 0001. The physical element the physical element number of which is 0004 is set so that it will permit access from the logical element the logical element number of which is 0001.

A physical element the physical element number of which is 0002 is assigned to a logical element the logical element number of which is 0003. This logical element is connected to the logical element the logical element number of which is 0004. The physical element the physical element number of which is 0002 functions as an AP server and the IP address “xxx.xxx.xxx.yyy” and the host name “ap1” are set.

A physical element the physical element number of which is 0006 is assigned to the logical element the logical element number of which is 0004. This logical element is connected to the logical elements the logical element numbers of which are 0001 and 0003 respectively. The physical element the physical element number of which is 0006 is set so that it will permit communication between the logical elements the logical element numbers of which are 0001 and 0003 respectively.

As described above, results regarding the functions of physical elements, setting contents, and logical connection are stored in the layout table 114. In this example, the setting contents are itemized in a natural language, but in reality they will be described in a computer language. For example, the settings of the logical element “0001” are as follows:
DB_SERVER=TRUE
IP_ADDRESS=xxx.xxx.xxx.xxx
HOST_NAME=db1

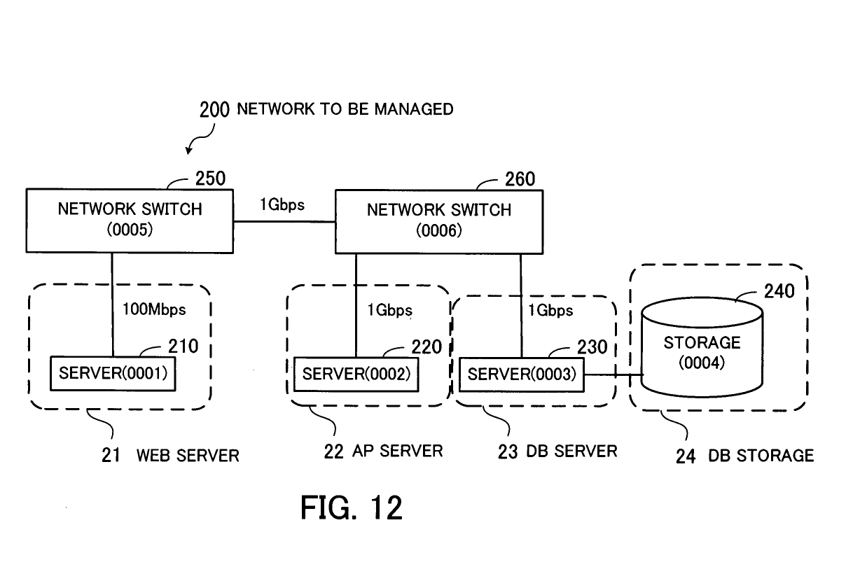

FIG. 12 shows an example of a generated system layout. In this example, the system layout is determined so that the server 210 will function as the Web server 21, so that the server 220 will function as the AP server 22, so that the server 230 will function as the DB server 23, and so that the storage 240 will function as the DB storage 24.

The system layout generated in this way is evaluated by the layout evaluation section 132c. A system layout is generated repeatedly until all of the system layouts capable of being generated are generated or until a system layout the evaluation value of which is greater than or equal to a predetermined value is generated. The system layout the evaluation value of which is greater than or equal to the predetermined value is registered with the system layout storage section 121 and is referred to by the setting file generation section 133 to extract set items.

A system layout is evaluated on the basis of the layout evaluation table 115.

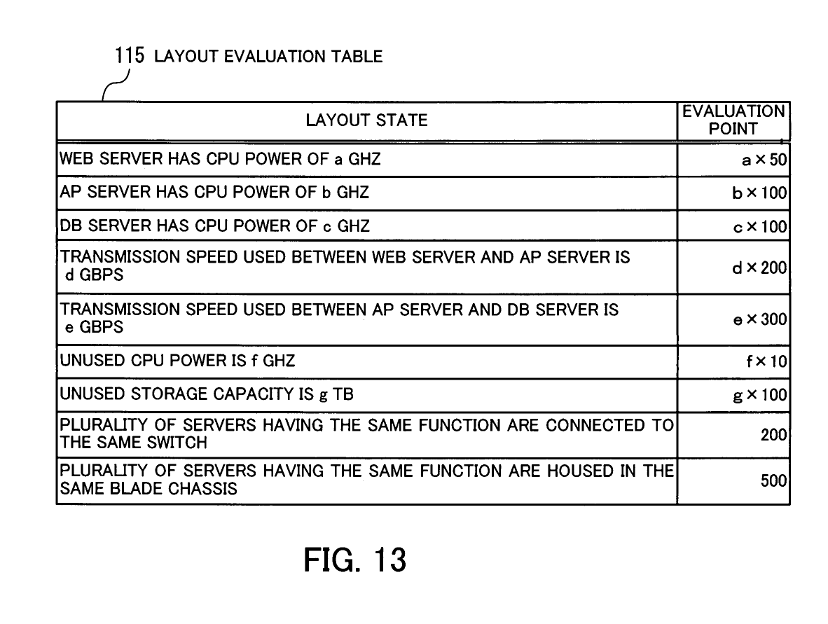

FIG. 13 shows an example of the data structure of a layout evaluation table. Layout states and evaluation points are associated with each other and are registered in the layout evaluation table 115. Layout State indicates a condition defined for evaluating a system layout. Evaluation Point indicates evaluation points given when each layout state is reached.

If a Web server determined in a system layout has a CPU power of a GHz (a is a real number that indicates the operating frequency of the CPU in gigahertz), then the evaluation points a×50 are given.

If an AP server determined in a system layout has a CPU power of b GHz (b is a real number that indicates the operating frequency of the CPU in gigahertz), then the evaluation points b×100 are given.

If a DB server determined in a system layout has a CPU power of c GHz (c is a real number that indicates the operating frequency of the CPU in gigahertz), then the evaluation points c×100 are given.

If transmission speed used between a Web server and an AP server determined in a system layout is d Gbps (d is a real number that indicates a transmission speed in bits per second), then the evaluation points d×200 are given.

If transmission speed used between an AP server and a DB server determined in a system layout is e Gbps (e is a real number that indicates a transmission speed in bits per second), then the evaluation points e×300 are given.

If unused CPU power in a system determined in a system layout is f GHz (f is a real number that indicates the operating frequency of the CPU in gigahertz), then the evaluation points f×10 are given.

If unused storage capacity in a system determined in a system layout is g TB (g is a real number that indicates storage capacity in terabytes), then the evaluation points g×100 are given.

If a plurality of servers having the same function are connected to the same switch in a system determined in a system layout, then the evaluation points 200 are given.

If a plurality of servers having the same function are housed in the same blade chassis in a system determined in a system layout, then the evaluation points 500 are given.

A system layout is evaluated on the basis of such a evaluation table. If one system layout applies to a plurality of layout states, the evaluation value of the system layout is obtained by totaling evaluation points corresponding to these layout states.

Layout verification requirements may be registered in the layout evaluation table 115. In this case, only a system layout that meets the layout verification requirements can be selected as a design result. To be concrete, the layout evaluation section 132c simulates a generated system layout on the basis of physical system information stored in the physical system information table 113 and the layout verification requirements stored in the layout evaluation table 115 and predicts various situations and resource performance. Then the layout evaluation section 132c verifies whether the system layout meets the layout verification requirements. If the system layout does not meet the layout verification requirements, the layout evaluation section 132c does not select the system layout as a design result regardless of the evaluation points of the system layout.

A procedure for a physical system layout design process will now be described concretely.

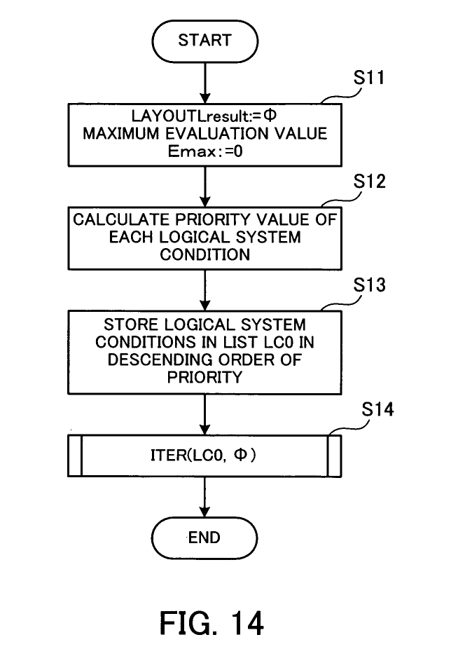

FIG. 14 is a flow chart showing a procedure for a physical system layout design process. The process shown in FIG. 14 will now be described in order of step number.

[Step S11] The layout implementation section 132b initializes the layout table 114. To be concrete, the layout implementation section 132b removes a layout design result (Lresult) indicative of a generated system layout (makes a storage area empty “Φ”). In addition, layout implementation section 132b sets the maximum evaluation value Emax of a system layout to zero. If a partial layout has already been determined, the determined partial layout is set as the initial value of a layout (Lresult).

[Step S12] The priority value calculation section 132a extracts logical system conditions from the logical system condition table 112 one at a time and calculates the priority value of each logical system condition. To be concrete, the priority value calculation section 132a refers to the priority value setting table 111 and extracts all of the condition types to which an extracted logical system condition applies. Then the priority value calculation section 132a makes the total of priority values associated with the extracted condition types the priority value of the logical system condition. The calculated priority value is set in the logical system condition table 112.

[Step S13] The layout implementation section 132b stores the logical system conditions in a list LC0 in descending order of priority.

[Step S14] The layout implementation section 132b invokes a layout generation process (ITER(LC, L)) with the list LC0 generated in step S13 as a condition list LC and a layout L, being a variable, set to empty “Φ” (ITER(LC0, Φ).

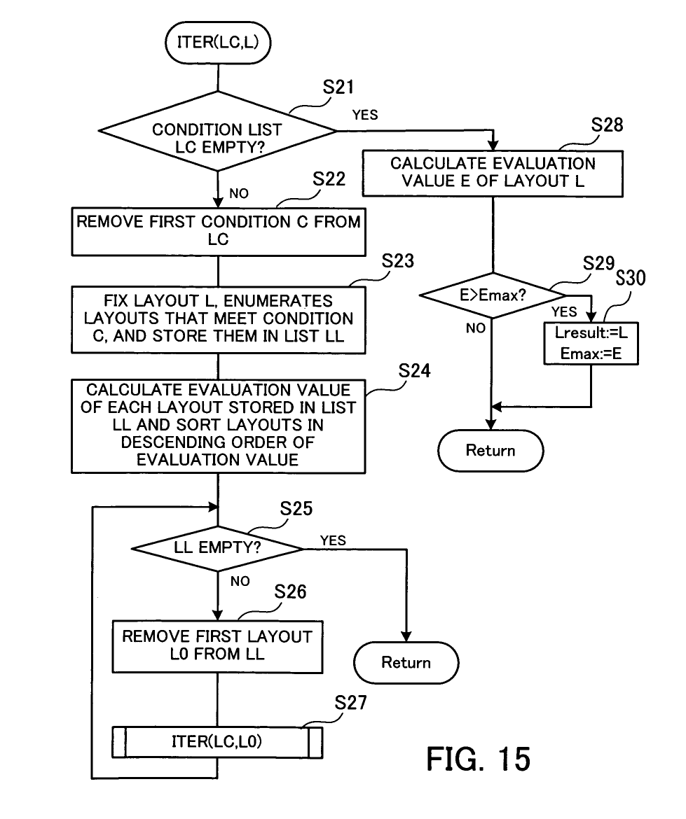

FIG. 15 is a flow chart showing a procedure for a layout generation process. The process shown in FIG. 15 will now be described in order of step number.

[Step S21] The layout implementation section 132b determines whether the condition list LC is empty. If the condition list LC is empty, then step S28 is performed. If logical system conditions remain in the condition list LC, then step S22 is performed.

[Step S22] The layout implementation section 132b removes a first condition C from the condition list LC.

[Step S23] The layout implementation section 132b fixes the layout L, enumerates layouts that meet the condition C removed in step S22 (assignment of a function to physical elements that meet the condition C), and stores these layouts in a list LL. That is to say, the layout implementation section 132b generates layouts that meet the condition C as many as possible without changing the layout L that has already been established.

[Step S24] The layout evaluation section 132c calculates the evaluation value of a layout Li stored in the list LL by referring to the layout evaluation table 115. To be concrete, the layout evaluation section 132c extracts layout states the layout Li reaches from the layout evaluation table 115 and makes the total of evaluation points corresponding to the extracted layout states the evaluation value of the layout Li. Then the layout implementation section 132b sorts layouts stored in the list LL in descending order of evaluation value.

[Step S25] The layout implementation section 132b determines whether the list LL is empty. If the list LL is empty, then the process returns to the step from which the layout generation process was invoked. If the list LL is not empty, then step S26 is performed.

[Step S26] The layout implementation section 132b removes a first layout L0 from the list LL.

[Step S27] The layout implementation section 132b invokes (ITER(LC, L0) a layout generation process (ITER(LC, L)) with the current condition list LC and the layout L0 removed in step S26 as variables. When the process invoked terminates, step S25 is performed. If a layout generation process is invoked in step S27 when the condition list LC becomes empty as a result of removing the condition C in step S22, then the layout implementation section 132b determines in step S21, to which the layout generation process was invoked, that the condition list LC is empty, and step S28 is performed.

[Step S28] The layout evaluation section 132c calculates the evaluation value E of a layout L. The evaluation value of the layout L is calculated in step S24 from which the layout generation process was invoked, so this value can be used.

[Step S29] The layout evaluation section 132c determines whether the evaluation value E is greater than the maximum evaluation value Emax. If the evaluation value E is greater than the maximum evaluation value Emax, then step S30 is performed. If the evaluation value E is smaller than the maximum evaluation value Emax, then the process returns to the step from which the layout generation process was invoked.

[Step S30] The layout implementation section 132b sets the layout L inputted as a variable in the current layout generation process as the layout design result (Lresult). In addition, the layout implementation section 132b sets the evaluation value E of the layout L inputted as a variable in the current layout generation process as the maximum evaluation value Emax. Then the process returns to the step from which the layout generation process was invoked.

An example of the design of a system layout that meets the logical system conditions shown in FIG. 7 will now be described with reference to the layout table 114 shown in FIG. 11. By referring to the logical system condition table 112, it is known that the priority value of the logical system condition to which the condition number “0003” is assigned is the greatest. Therefore, the process of generating a layout that meets the condition “a vendor name should be Vendor2, a unit type name should be Model2, and one DB server should have a CPU power of 2 GHz” is performed. As a result, the decision that the physical element (server 230) to which the physical element number “0003” is assigned should be used as the DB server is made and is registered in the layout table 114 as the logical element number “0001”.

Next, the logical system condition (condition number “0004”) the priority value of which is the second greatest is extracted from the logical system condition table 112 and the process of generating a layout that meets the condition “DB storage capacity should be 500 GB (0.5 TB)” is performed. As a result, the decision that access from the physical element “0003” corresponding to the logical element number “0001” should be permitted in the physical element (storage 240) to which the physical element number “0004” is assigned is made and is registered in the layout table 114 as the logical element number “0002”. In this case, “0002” is registered as a logical element to which the logical element numbered “0001” is connected, and “0001” is registered as a logical element to which the logical element numbered “0002” is connected.

Then the logical system condition (condition number “0002”) the priority value of which is the third greatest is extracted from the logical system condition table 112 and the process of generating a layout that meets the condition “a vendor name should be Vendor1 and an AP server should have a CPU power of 1 GHz” is performed. As a result, the decision that the physical element (server 220) to which the physical element number “0002” is assigned should be used as the AP server is made and is registered in the layout table 114 as the logical element number “0003”.

In this case, the physical element (server 220) to which the physical element number “0002” is assigned and the physical element (storage 240) to which the physical element number “0004” is assigned must be connected. Accordingly, the decision that communication between the physical elements “0002” and “0003” should be permitted in the physical element (switch 260) to which the physical element number “0006” is assigned is made and is registered in the layout table 114 as the logical element number “0004”. At the same time “0004” is registered as a logical element to which the logical element numbered “0001” is connected, “0004” is registered as a logical element to which the logical element numbered “0003” is connected, and “0001” and “0003” are registered as logical elements to which the logical element numbered “0004” is connected.

The logical system conditions are extracted from the logical system condition table 112 in descending order of priority value in this way and a layout is built. If no physical element meets a logical system condition, then the process is returned to the generation of a layout that meets the preceding logical system condition (rollback). Then a layout different from that generated the last time is generated and a layout that meets the following logical system conditions is built on the basis of this new layout.

Among system layouts that meet the logical system conditions in the above way, a system layout the evaluation value of which is the greatest can be made a layout design result. Accordingly, if many system layouts that meet the logical system conditions can be generated, the most efficient system layout can be selected as a system layout for the network 200 to be managed.

The layout generation process can be terminated at the time when a predetermined criterion for terminating the layout generation process is satisfied. For example, the layout generation process can be terminated at the time when the maximum evaluation value Emax exceeds a predetermined value (threshold). As a result, the system layout generation process can be performed in a short period of time. That is to say, with an increase in the scale of the network 200 to be managed, the number of system layouts that meet the logical system conditions will increase. Therefore, processing efficiency can be raised by terminating the system layout generation process at the time when a system layout the evaluation value of which is greater than or equal to the predetermined value is generated.

Moreover, in the first embodiment, priority is set for the logical system conditions and a system layout that meets a logical system condition to which high priority is assigned is preferentially generated. Accordingly, even if the layout generation process is terminated with predetermined timing, a system layout the evaluation value of which is great can be obtained as a layout design result (Lresult).

Furthermore, in the first embodiment, a depth-first search (DFS) is performed on layouts in descending order of evaluation value. In this depth-first search, edges are followed from one vertex as far as possible. When it is impossible to go further, the return is made to select another route. That is to say, in the first embodiment, a system layout the evaluation value of which is great is selected from among system layouts that meet a logical system condition, and a system layout that also meets another logical system condition is generated on the basis of the selected system layout. As described above, by building a system layout that meets each logical system condition on the basis of a system layout selected in descending order of evaluation value, a system layout the evaluation value of which is greater than a predetermined value can be generated quickly.

Moreover, a method which is called pruning may be adopted as one of methods for performing a system layout design process at high speed. In the pruning, the greatest evaluation value of a layout generated on the basis of the current partial layout L is estimated as Estimate at the beginning of the layout generation process (ITER(LC, L). If Estimate does not exceed Emax, it is meaningless to perform a search on the basis of the partial layout L. Therefore, a search is not performed. This avoids unnecessary search processes and enables efficient processing.

In this case, the greatest evaluation value should be estimated optimistically without consideration for detailed conditions to prevent the occurrence of a situation where a layout generation process capable of generating a layout the evaluation value of which is greater than Emax is not performed accidentally. For example, if a network on which a maximum transmission speed of 100 Mbps can be used is left, then a transmission speed will be evaluated on the assumption that all of the nodes can use the network in the subsequent layout regardless of the number of ports.

In addition, by reusing partial evaluation, a system layout design process can be performed at high speed. That is to say, the result of an evaluation of a partial layout is recorded and is reused for evaluating, or estimating the evaluation value of, the same partial layout.

Furthermore, by providing feedback from failures, a system layout design process can be performed at high speed. To be concrete, if there is no possible layout under the partial layout L, then the layout implementation section 132b searches for a fatal condition. Possible fatal conditions are as follows:
logical system condition handled last
logical system condition that provides a small number of possible layouts

The layout implementation section 132b rearranges a condition list so that a search regarding the fatal condition will be made at an earlier stage in the following process. For example, it is assumed that after locating a Web server, handling the condition “FW (DMZ port) should be secured” results in failure. Then this condition is considered to be fatal. In the following process, FW (DMZ port) is secured before the Web server is located.

Even if all of the system layout ultimately fail, a fatal condition found can be indicated to a user. By doing so, the possibility that there might be a defect in the configuration of a physical system can be indicated and advice can be given about the expansion or modification of the current system.

The function (deployment) of making physical elements on the network 200 to be managed reflect a system layout result will now be described.

When a system layout is designed and is registered with the system layout storage section 121, the setting file generation section 133 registers set items for each physical element in the setting file DB 122. In the first embodiment, the setting file generation section 133 has a setting file template. A setting file in which set items for each physical element and the contents of the set items are described is generated on the basis of the setting file template. The setting file template is managed by a setting file template table.

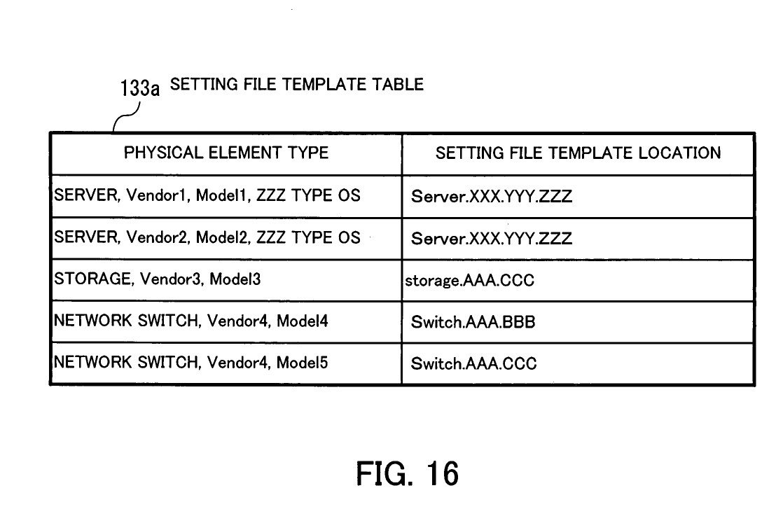

FIG. 16 shows an example of the data structure of a setting file template table. Physical element types and setting file template locations are associated with each other and are registered in a setting file template table 133a. Physical Element Type indicates the type of each physical element included in the network 200 to be managed. Setting File Template Location indicates the location (path in file structure and file name) of a setting file template corresponding to each physical element type.

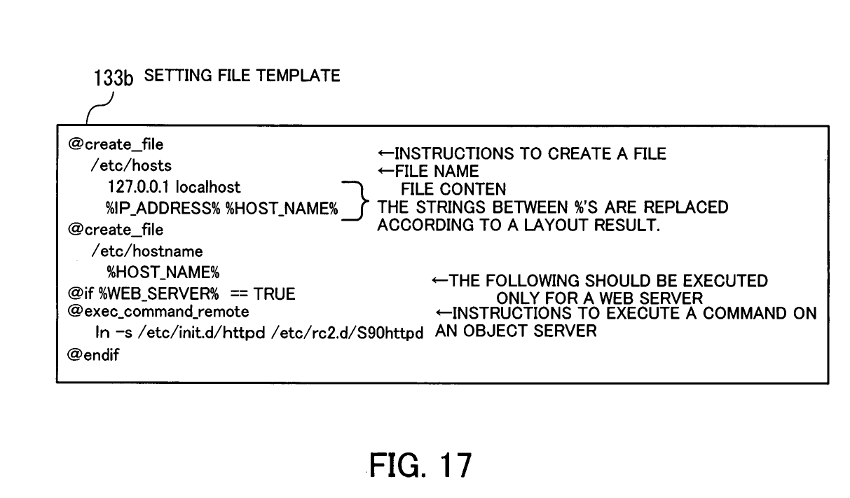

FIG. 17 shows an example of a set file template. A combination of the file name designation “@create_file,” the file name “/etc/hosts,” and the file contents “127.0.0.1 localhost %IP_ADDRESS% %HOST_NAME%” is described in a setting file template 133b. Moreover, “@if%WEB_SERVER%==TRUE” indicates that the following process should be performed only for a Web server. “@exec_command_remote” indicates that the command “ln-s/etc/init.d/httpd/etc/rc2.d/S90httpd” should be executed on an object server.

The strings between %'s in the file contents are replaced according to a system layout design result. Values with which “%IP_ADDRESS%,” “%HOST_NAME%,” and “%WEB_SERVER%” are replaced are determined by referring to a field for setting each physical element stored in the system layout storage section 121.

A setting file for each physical element is generated on the basis of the above setting file template 133b. The generated setting file is stored in the setting file DB 122. A setting file management table for managing setting files stored is included in the setting file DB 122.

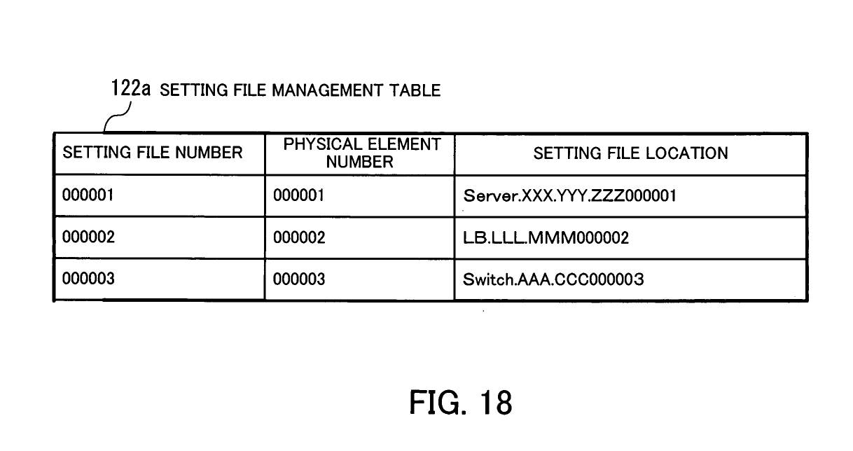

FIG. 18 shows an example of the data structure of a setting file management table. Setting file numbers, physical element numbers, setting file locations are associated with one another and are registered in a setting file management table 122a. Setting File Number indicates the identification number of each setting file generated. Physical Element Number indicates the identification number of a physical element corresponding to each setting file. Setting File Location indicates the location (path in the file structure and file name) of each setting file generated.

When a setting file and the setting file management table 122a are stored in the setting file DB 122, the configuration control management section 134 sends the setting file to a configuration control agent included in a physical element on the network 200 to be managed. The configuration control management section 134 manages the location of a configuration control agent included in each physical element by a configuration control agent management table.

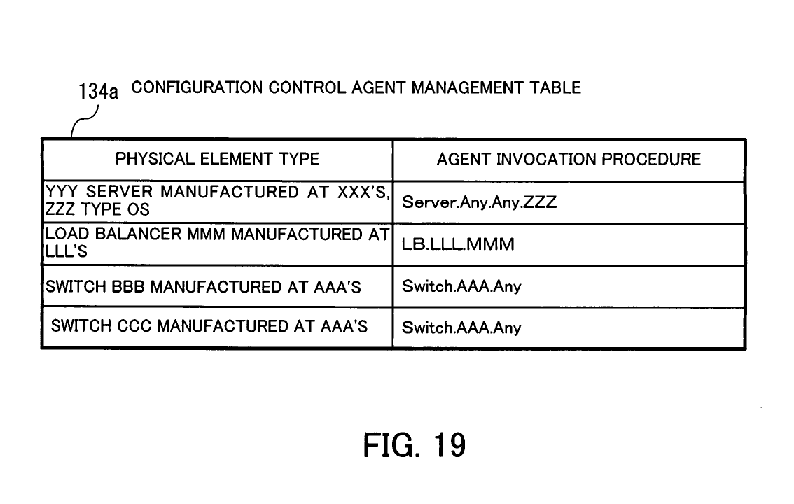

FIG. 19 shows an example of the data structure of a configuration control agent management table. Physical element types and agent invocation procedures are associated with each other and are registered in a configuration control agent management table 134a. Physical Element Type indicates the type of each physical element included in the network 200 to be managed. Agent Invocation Procedure indicates the location (path and file name) of a file indicative of a processing procedure (invocation procedure) for invoking a configuration control agent corresponding to each physical element type.

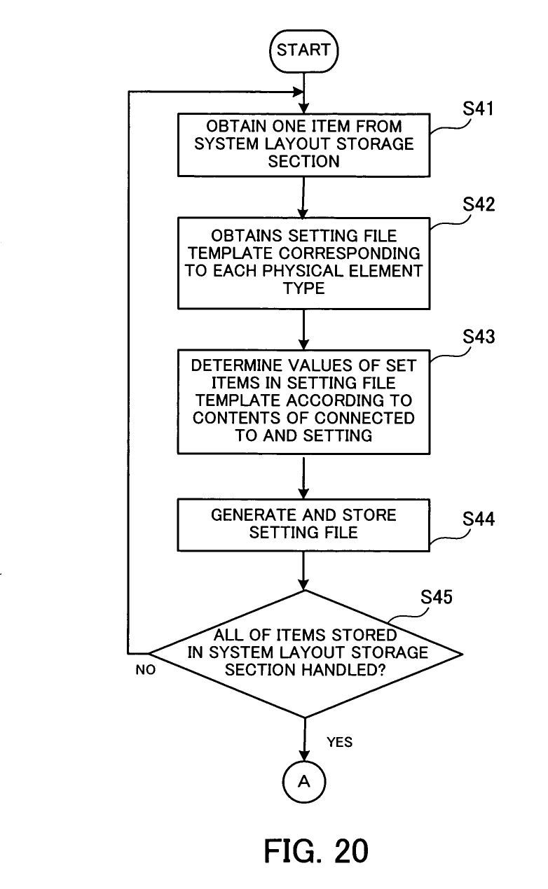

A procedure for the deployment process will now be described with reference to FIGS. 20 through 22.

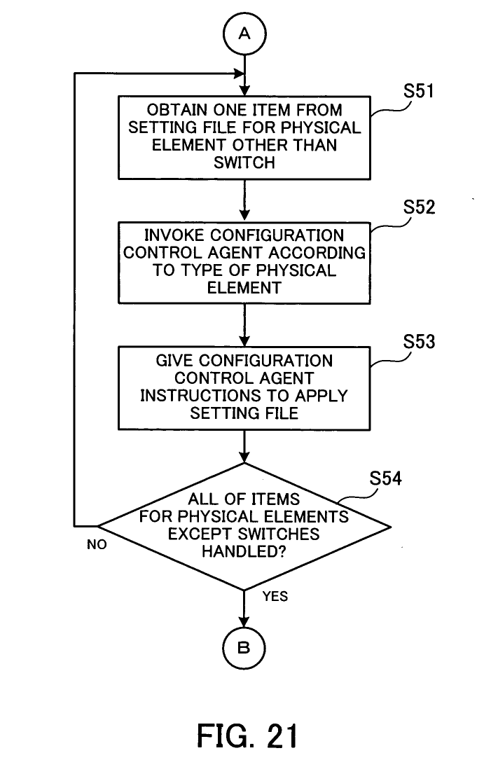

FIG. 20 is a first flow chart showing a procedure for a deployment process. The process shown in FIG. 20 will now be described in order of step number.

[Step S41] The setting file generation section 133 obtains one item from the system layout storage section 121.

[Step S42] The setting file generation section 133 obtains a setting file template corresponding to each physical element type.

[Step S43] The setting file generation section 133 determines the values of set items in the setting file template according to the contents of Connected to and Setting.

[Step S44] The setting file generation section 133 generates a setting file and stores it in the setting file DB 122.

[Step S45] The setting file generation section 133 checks whether all of the items stored in the system layout storage section 121 are handled. If all of the items stored in the system layout storage section 121 are handled, then step S51 (see FIG. 21) is performed. If there is an item still to be handled, then step S41 is performed.

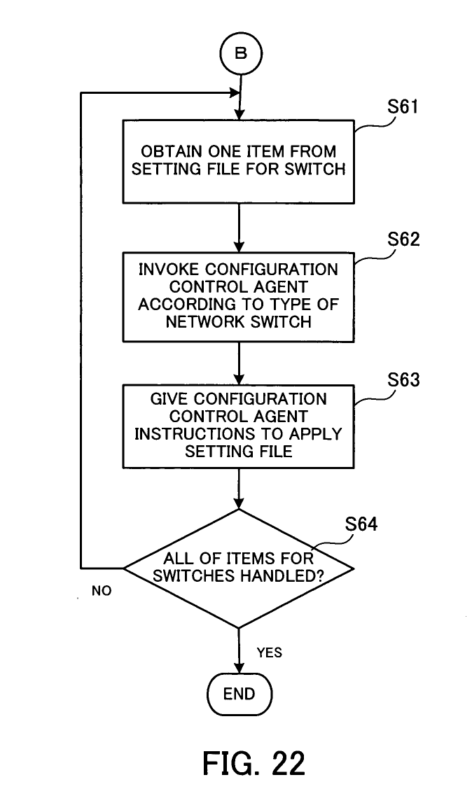

FIG. 21 is a second flow chart showing the procedure for the deployment process. The process shown in FIG. 21 will now be described in order of step number.

[Step S51] The configuration control management section 134 obtains one item from a setting file for a physical element other than a switch.

[Step S52] The configuration control management section 134 invokes a configuration control agent according to the type of the physical element.

[Step S53] The configuration control management section 134 sends the setting file to the configuration control agent and gives the configuration control agent instructions to apply the setting file.

[Step S54] The configuration control management section 134 checks whether all of the items for physical elements except switches are handled. If all of the applicable items are handled, then step S61 (see FIG. 22) is performed. If there is an item still to be handled, then step S51 is performed.

FIG. 22 is a third flow chart showing the procedure for the deployment process. The process shown in FIG. 22 will now be described in order of step number.

[Step S61] The configuration control management section 134 obtains one item from a setting file for a switch, being a physical element.

[Step S62] The configuration control management section 134 invokes a configuration control agent according to the type of the switch.

[Step S63] The configuration control management section 134 sends the setting file to the configuration control agent and gives the configuration control agent instructions to apply the setting file.

[Step S64] The configuration control management section 134 checks whether all of the items for switches are handled. If all of the applicable items are handled, then the process terminates. If there is an item still to be handled, then step S61 is performed.

As described above, in the deployment process, setting for the physical elements other than the switches is performed preferentially. If setting for the switches is performed before setting for the other physical elements, communication will be performed between physical elements between which the connection relationship is not adjusted (setting of the system layout determined is not yet completed). This may cause a problem. By preferentially setting the environments of the physical elements other than the switches, the network 200 to be managed that conforms to the system layout generated can be operated stably from the time when its operation is begun.

As described above, in the first embodiment, an efficient system layout for a network to be managed can be generated automatically and an environment suitable for the system layout can be built automatically. This lightens the load on an administrator who manages the network to be managed, and prevents a problem, such as a mistake in setting, from arising.

### Second Embodiment

In a second embodiment of the present invention, the convenience and reliability of a network system to be built is improved by extending the first embodiment. For example, the function of collecting information regarding a physical resource from each physical element on a network to be managed and automatically generating physical system information can be used as a technique for improving the convenience. In addition, a technique for previously simulating the operation of a physical element on the network to be managed for which items are set may be used for improving the reliability. To improve the reliability, a technique for actually monitoring the operation of a physical element and verifying the correctness of items set for the physical element may be used.

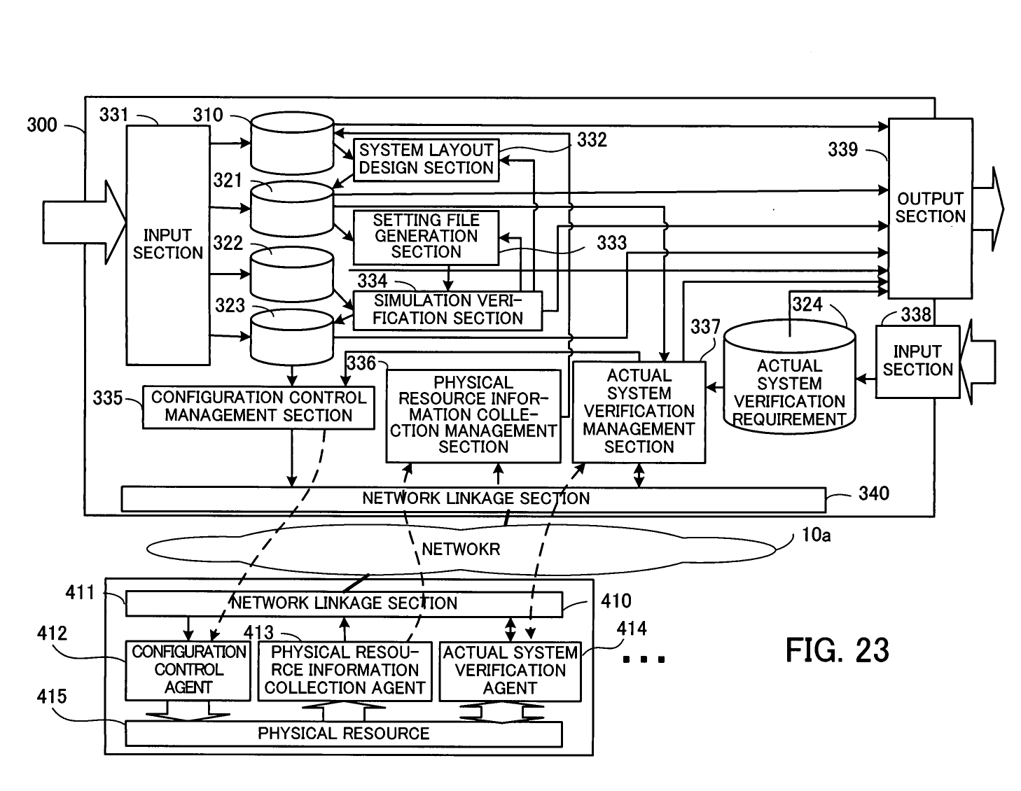

FIG. 23 shows an example of a system configuration according to a second embodiment of the present invention. A management node 300 and a node 410 to be managed are connected via a network 1a.

The management node 300 includes a layout design condition DB 310, a system layout storage section 321, a simulation item verification requirement 322, a setting file DB 323, an actual system verification requirement 324, an input section 331, a system layout design section 332, a setting file generation section 333, a simulation verification section 334, a configuration control management section 335, a physical resource information collection management section 336, an actual system verification management section 337, an input section 338, an output section 339, and a network linkage section 340.

The input sections 331 and 338 are user interface input sections in the management node 300. Data can be registered in the layout design condition DB 310, the system layout storage section 321, the simulation item verification requirement 322, the setting file DB 323, and the actual system verification requirement 324 via the input sections 331 and 338. In addition, data stored in the layout design condition DB 310, the system layout storage section 321, the simulation item verification requirement 322, the setting file DB 323, and the actual system verification requirement 324 can be altered via the input sections 331 and 338.

Information necessary for layout design for a network to be managed is registered in the layout design condition DB 310. The contents of the layout design condition DB 310 are the same as those of the layout design condition DB 110 in the first embodiment shown in FIG. 5.

The contents of a system layout designed are stored in the system layout storage section 321. The contents of the system layout storage section 321 are the same as those of the system layout storage section 121 in the first embodiment. The data structure of the system layout storage section 321 is the same as that of the layout table 114 shown in FIG. 11.

A verification requirement for a simulation performed according to the contents of set items is registered in the simulation item verification requirement 322.

Items to be set for the node 410 to be managed and the contents of the items are registered in the setting file DB 323.

Verification requirements for verifying the operation of the node 410 to be managed are registered in the actual system verification requirement 324. That is to say, requirements for verifying whether a deployment process has been performed properly on a network to be managed are registered. For example, the following verification requirements are registered.
Node operation check. This check is made by using the command “ping” on the node to be managed.
Application operation check. This check is made on the basis of a response obtained by passing sample data to each application in the node to be managed.
Link connection check. This check is made by using the command “ping” between two nodes.
Switching operation check. This check is made on the basis of a result obtained by performing forced switching at a redundant node.
Load distribution operation check. This check is made by applying a pseudo load.
Firewall operation check. This check is made by pseudo unauthorized access.
Storage operation check. This check is made on the basis of the result of disk operation on storage and response time.
End-to-end performance check. This check is made on the basis of time taken to make a response when sample data is fed from an entry to a system.

The system layout design section 332 designs a system layout for the network to be managed on the basis of the layout design condition DB 310. The system layout designed is registered in the system layout storage section 321. The function of the system layout design section 332 is the same as that of the system layout design section 132 in the first embodiment.

The setting file generation section 333 determines items to be set on the node 410 to be managed and the contents of the items on the basis of the system layout registered in the system layout storage section 321. The set items and their contents determined are registered in the setting file DB 323. The function of the setting file generation section 333 is the same as that of the setting file generation section 133 in the first embodiment.

The configuration control management section 335 sends the contents of the set items registered in the setting file DB 323 to the node 410 to be managed and requests the node 410 to be managed to set the items. The function of the configuration control management section 335 is the same as that of the configuration control management section 134 in the first embodiment. When the configuration control management section 335 receives notice that the node 410 to be managed does not perform a predetermined function from the actual system verification management section 337, the configuration control management section 335 sets the items again on the node 410 to be managed.

The physical resource information collection management section 336 collects attribute information for a physical resource from the node 410 to be managed. If a physical resource is an HDD, attribute information includes storage capacity, empty capacity, etc. Then the physical resource information collection management section 336 registers the information it collected in a physical system information table in the layout design condition DB 310.

Furthermore, the physical resource information collection management section 336 can collect failure information and performance information from the node 410 to be managed. The physical resource information collection management section 336 registers the failure information and the performance information it collected in the physical system information table in the layout design condition DB 310. In this case, the system layout design section 332 can design the system layout on the basis of latest information, such as the failure information and the performance information.

In addition, the physical resource information collection management section 336 can automatically detect the addition (first participation in the network to be managed), the elimination (disconnection from the network to be managed), or modification (modification in hardware configuration) of the node to be managed. When the physical resource information collection management section 336 detects the addition, the elimination, or modification of the node to be managed, the physical resource information collection management section 336 makes the physical system information table reflect its contents and makes the system layout design section 332 redesign a system layout.

The actual system verification management section 337 collects information indicative of the operating state of the system from the node 410 to be managed. Then the actual system verification management section 337 refers to the system layout storage section 321 and the actual system verification requirement 324 and verifies the operating state of the node 410 to be managed on the basis of the actual system verification requirement 324. For example, the actual system verification management section 337 checks the validity of the physical system layout by sending test data to an actual system, such as the node 410 to be managed. A function to be performed by the node 410 to be managed can be determined by referring to the system layout storage section 321. A verification result is outputted via the output section 339 and is communicated to the configuration control management section 335.

The output section 339 is a user interface for output from the management node 300. The output section 339 displays the contents of data on the monitor or stores data in another unit.

When the node 410 to be managed is added, eliminated, or modified, the network linkage section 340 distributes or recovers its IP address automatically and ensures security.

The node 410 to be managed includes a network linkage section 411, a configuration control agent 412, a physical resource information collection agent 413, an actual system verification agent 414, and a physical resource 415.

For example, in response to a request from the network linkage section 340 in the management node 300, the network linkage section 411 distributes or recovers the IP address automatically and ensures security.

The configuration control agent 412 sets an environment for the physical resource 415 in compliance with a request from the configuration control management section 335.

The physical resource information collection agent 413 collects information indicative of the configuration of the physical resource 415 in the node 410 to be managed and passes it to the physical resource information collection management section 336 in the management node 300.

The actual system verification agent 414 collects information indicative of the operating state of the physical resource 415 and passes it to the actual system verification management section 337 in the management node 300.

In addition to the system layout design process and the deployment process by the first embodiment, a physical resource information collection process, a set item simulation verification process, and an actual system verification process are performed by the above system. These additional processes will now be described.

A physical resource information collection process will be described first. The physical resource information collection management section 336 collects information regarding the physical resource in the node 410 to be managed in cooperation with the physical resource information collection agent 413 in the node 410 to be managed and stores it in the physical system information table in the layout design condition DB 310. The information regarding the physical resource stored in the physical system information table is made visible (displayed on the monitor) by the output section 339, so its contents can be checked.

The information regarding the physical resource on the actual network to be managed can automatically be collected in this way. This saves an administrator the trouble of inputting information set for the physical resource and prevents a mistake in input caused by manual operation.

Next, a set item simulation process will be described. The first step to the step of creating a setting file DB in the set item simulation process are the same as those in the first embodiment. That is to say, a logical system layout inputted from the input section 331 is stored in a logical system condition table in the layout design condition DB 310. This information is made visible (displayed on the monitor) by the output section 339, so its contents can be checked. The system layout design section 332 designs a physical system layout in which the current state of the physical resource is reflected on the basis of the logical system layout stored in the logical system condition table and the information regarding the physical resource stored in the physical system information table. Then the system layout design section 332 stores the system layout in the system layout storage section 321. The setting file generation section 333 generates a setting file, such as a batch file or a disk image, on the basis of the system layout stored in the system layout storage section 321.

The setting file generation section 333 passes the setting file to the simulation verification section 334. The simulation verification section 334 simulates a result obtained by applying the setting file to the node 410 to be managed in accordance with the simulation item verification requirement 322. In this simulation, various situations and resource performance are predicted. Whether a problem arises is verified by this simulation. If the simulation verification section 334 detects a problem with the system layout, then the simulation verification section 334 displays the contents of the problem via the output section 339 in order to prompt the administrator to modify the system layout. If the simulation verification section 334 detects no problem with the system layout, then the simulation verification section 334 indicates via the output section 339 that there is no problem with the system layout. In this case, the setting file is stored in the setting file DB 323.

Furthermore, if the simulation verification section 334 detects a problem with the system layout by the simulation, then the simulation verification section 334 may inform the system layout design section 332 about the contents of the problem in order to make it redesign a system layout. In this case, the system layout design section 332 outputs a layout which is selected from among layouts different from the system layout having the problem and the evaluation value of which is great to the system layout storage section 321 as a processing result.

When the setting file which passes verification by the simulation verification section 334 is stored in the setting file DB 323, the configuration control management section 335 sends the setting file to the node 410 to be managed. Then the configuration control agent 412 sets an environment for the physical resource 415.

As described above, a simulation regarding set items will prevent a set item the contents of which are wrong from being set on a node to be managed. This improves the reliability of the operation of a network to be managed.

Finally, an actual system verification process will be described. The actual system verification agent 414 monitors the operating state of the physical resource 415 and sends information indicative of the operating state of the physical resource 415 to the actual system verification management section 337 in the management node 300. The actual system verification management section 337 collects information indicative of the operating state of each server and verifies on the basis of the actual system verification requirement 324 whether an actual system is built according to the system layout stored in the system layout storage section 321. If the actual system is not built according to the system layout stored in the system layout storage section 321, then the actual system verification management section 337 gives the configuration control management section 335 notice to that effect. Then the configuration control management section 335 again exercises configuration control over a physical element which is not built correctly. If there is no problem, then the actual system verification management section 337 indicates to that effect via the output section 339.

As described above, whether a network to be managed is built according to a system layout designed is verified. An environment for a physical element which is not built correctly can be set automatically. This improves the reliability of the operation of the network to be managed.

As described above, in each of the above embodiments, an environment for each node to be managed can be set automatically on the basis of the logical system conditions. This significantly improves the speed of building a system. In addition, automation eliminates operation mistakes which have been at stake so far, resulting in greater accuracy in building a system.

Information registered in the system layout storage section 121 and 321, the setting file DBs 122 and 323, etc. may be generated automatically by the management nodes 100 and 300 or may be set manually by the administrator via the input sections 131 and 331.

The above functions can be realized with a computer. In this case, a program in which the contents of the functions the management nodes and the nodes to be managed should have are described is provided. By executing this program on the computer, the above functions are realized on the computer. This program can be recorded on a computer readable record medium. A computer readable record medium can be a magnetic recording device, an optical disk, a magneto-optical recording medium, a semiconductor memory, or the like. A magnetic recording device can be a hard disk drive (HDD), a flexible disk (FD), a magnetic tape, or the like. An optical disk can be a digital versatile disk (DVD), a digital versatile disk random access memory (DVD-RAM), a compact disk read only memory (CD-ROM), a compact disk recordable (CD-R)/rewritable (CD-RW), or the like. A magneto-optical recording medium can be a magneto-optical disk (MO) or the like.

To place the program on the market, portable record media, such as DVDs or CD-ROMs, on which it is recorded are sold. Alternatively, the program is stored in advance on a hard disk in a server computer and is transferred from the server computer to another computer via a network.

When the computer executes this program, it will store the program, which is recorded on a portable record medium or which is transferred from the server computer, on, for example, its hard disk. Then it reads the program from its hard disk and performs processes in compliance with the program. The computer canal so read the program directly from a portable record medium and perform processes in compliance with the program. Furthermore, each time the program is transferred from the server computer, the computer can perform processes in turn in compliance with the program it receives.

As has been described in the foregoing, in the present invention, system layouts generated by the system layout generation section are evaluated by the layout evaluation section and a system layout the evaluation value of which is the greatest is treated as a design result. Therefore, even if a network to be managed is large-scale, a system layout that best fits predetermined criteria regarding efficiency and the like can be designed.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A system layout design program for determining the arrangement of a plurality of functions on a network to be managed by making a computer perform a process, the process comprising:
a storage step for storing a logical system condition table in which a plurality of logical system conditions indicative of functions to be performed on the network to be managed are stored and a physical system information table in which physical element information indicative of a plurality of units included in the network to be managed and the connection state of the plurality of units is stored in a storage unit;
a system layout generation step for associating the plurality of units for performing the functions indicated by the plurality of logical system conditions with the plurality of logical system conditions, and for generating system layouts indicative of the association of the plurality of units with all of the plurality of logical system conditions; and
an evaluation step for evaluating the system layouts generated in the system layout generation step on the basis of evaluation criteria designated in advance, and for storing a system layout evaluated most highly in a system layout storage section as a design result.

2. The system layout design program according to claim 1, wherein:
priority is set among the plurality of logical system conditions stored in the logical system condition table; and
in the system layout generation step, the plurality of units for performing the functions indicated by the plurality of logical system conditions are associated with the plurality of logical system conditions in descending order of priority.

3. The system layout design program according to claim 1, wherein:
each time a system layout is generated in the system layout generation step, an evaluation value indicative of the evaluation of the system layout generated is calculated in the evaluation step; and
a system layout the evaluation value of which is greater than or equal to a predetermined value is treated as a design result.

4. The system layout design program according to claim 1, wherein if there are a plurality of patterns for the association of the plurality of units for performing the functions indicated by the plurality of logical system conditions with the plurality of logical system conditions, an evaluation of a partial layout indicated in each association pattern is obtained in the evaluation step, a partial layout highly evaluated is fixed, and the plurality of units associated with other logical system conditions are examined in the system layout generation step.

5. The system layout design program according to claim 1, wherein the program further makes the computer perform a setting file generation process for generating a setting file for implementing functions that conform to the system layout stored in the system layout storage section on the plurality of units included in the network to be managed on the basis of the system layout stored in the system layout storage section.

6. The system layout design program according to claim 5, wherein in the setting file generation process, the setting file for each of the plurality of units is generated by putting information regarding each of the plurality of units in the system layout stored in the system layout storage section into predetermined positions in a setting file template prepared.

7. The system layout design program according to claim 1, wherein the program further makes the computer perform a configuration control management process for remotely controlling the plurality of units included in the network to be managed and for setting an environment for each of the plurality of units on the basis of the setting file generated in the setting file generation process.

8. The system layout design program according to claim 7, wherein in the configuration control management process, an environment for each switch located on a communication channel between two of the plurality of units is set last.

9. The system layout design program according to claim 7, wherein the program further makes the computer perform an actual system verification process for collecting the operating state of the plurality of units included in the network to be managed and for verifying whether a system is built according to the system layout stored in the system layout storage section.

10. The system layout design program according to claim 1, wherein the program further makes the computer perform a physical resource information collection process for collecting physical element information from the plurality of units included in the network to be managed and for registering the physical element information in a physical system information table.

11. The system layout design program according to claim 1, wherein the program further makes the computer perform a simulation verification process for simulating a result obtained by applying the system layout stored in the system layout storage section to the plurality of units included in the network to be managed and for verifying whether a problem arises.

12. A system layout design apparatus for determining the arrangement of a plurality of functions on a network to be managed, the apparatus comprising:
a logical system condition table in which a plurality of logical system conditions indicative of functions to be performed on the network to be managed are stored;
a physical system information table in which physical element information indicative of a plurality of units included in the network to be managed and the connection state of the plurality of units is stored;
a system layout generation section for associating the plurality of units for performing the functions indicated by the plurality of logical system conditions with the plurality of logical system conditions, and for generating system layouts indicative of the association of the plurality of units with all of the plurality of logical system conditions; and
an evaluation section for evaluating the system layouts generated by the system layout generation section on the basis of evaluation criteria designated in advance, and for storing a system layout evaluated most highly in a system layout storage section as a design result.

13. A system layout design method for determining the arrangement of a plurality of functions on a network to be managed, the method comprising:
a step performed by an input section for storing a logical system condition table in which a plurality of logical system conditions indicative of functions to be performed on the network to be managed are stored and a physical system information table in which physical element information indicative of a plurality of units included in the network to be managed and the connection state of the plurality of units is stored in a storage unit;
a step performed by a system layout generation section for associating the plurality of units for performing the functions indicated by the plurality of logical system conditions with the plurality of logical system conditions and for generating system layouts indicative of the association of the plurality of units with all of the plurality of logical system conditions; and
a step performed by an evaluation section for evaluating the system layouts generated by the system layout generation section on the basis of evaluation criteria designated in advance and for storing a system layout evaluated most highly in a system layout storage section as a design result.

14. A computer-readable record medium that stores a system layout design program for determining the arrangement of a plurality of functions on a network to be managed by making a computer perform a process, the process comprising:
a storage step for storing a logical system condition table in which a plurality of logical system conditions indicative of functions to be performed on the network to be managed are stored and a physical system information table in which physical element information indicative of a plurality of units included in the network to be managed and the connection state of the plurality of units is stored in a storage unit;
a system layout generation step for associating the plurality of units for performing the functions indicated by the plurality of logical system conditions with the plurality of logical system conditions, and for generating system layouts indicative of the association of the plurality of units with all of the plurality of logical system conditions; and
an evaluation step for evaluating the system layouts generated in the system layout generation step on the basis of evaluation criteria designated in advance, and for storing a system layout evaluated most highly in a system layout storage section as a design result.
